(19) United States
(12) Patent Application Publication
(10) Pub. No.: US 2022/0147607 A1
(43) Pub. Date: May 12, 2022

(54) SYSTEM AND METHODS FOR IMPLEMENTING PRIVATE IDENTITY

(71) Applicant: Private Identity LLC, Potomac, MD (US)

(72) Inventor: Scott Edward Streit, Woodbine, MD (US)

(73) Assignee: Private Identity LLC, Potomac, MD (US)

(21) Appl. No.: 17/583,726

(22) Filed: Jan. 25, 2022

Related U.S. Application Data
(63) Continuation-in-part of application No. 17/560,813, filed on Dec. 23, 2021.
Application No. 17/560,813 is a continuation of application No. 16/218,139, filed on Dec. 12, 2018, now Pat. No. 11,210,375.
Application No. 16/218,139 is a continuation-in-part of application No. 15/914,562, filed on Mar. 7, 2018.
Application No. 15/914,562 is a continuation-in-part of application No. 15/914,942, filed on Mar. 7, 2018, now Pat. No. 10,721,070.
Application No. 15/914,942 is a continuation-in-part of application No. 15/914,969, filed on Mar. 7, 2018, now Pat. No. 11,138,333.
Application No. 15/914,969 is a continuation-in-part of application No. 17/521,400, filed on Nov. 8, 2021.
Application No. 17/521,400 is a continuation of application No. 16/022,101, filed on Jun. 28, 2018, now Pat. No. 11,170,084.
Application No. 16/022,101 is a continuation-in-part of application No. 17/492,775, filed on Oct. 4, 2021.
Application No. 17/492,775 is a continuation of application No. 15/914,969, filed on Mar. 7, 2018, now Pat. No. 11,138,333.
Application No. 15/914,969 is a continuation-in-part of application No. 17/473,360, filed on Sep. 13, 2021.
Application No. 17/473,360 is a continuation of application No. 17/183,950, filed on Feb. 24, 2021, now Pat. No. 11,122,078.
Application No. 17/183,950 is a continuation of application No. 16/993,596, filed on Aug. 14, 2020, now Pat. No. 10,938,852.
Application No. 16/993,596 is a continuation-in-part of application No. 17/398,555, filed on Aug. 10, 2021.
Application No. 17/398,555 is a continuation-in-part of application No. 17/183,950, filed on Feb. 24, 2021, now Pat. No. 11,122,078.
Application No. 17/183,950 is a continuation-in-part of application No. 17/155,890, filed on Jan. 22, 2021.
Application No. 17/155,890 is a continuation-in-part of application No. 16/993,596, filed on Aug. 14, 2020, now Pat. No. 10,938,852.
Application No. 16/993,596 is a continuation-in-part of application No. 16/832,014, filed on Mar. 27, 2020.
Application No. 16/832,014 is a continuation-in-part of application No. 16/573,851, filed on Sep. 17, 2019.
Application No. 16/573,851 is a continuation-in-part of application No. 16/539,824, filed on Aug. 13, 2019, now Pat. No. 11,265,168.
Application No. 16/539,824 is a continuation-in-part of application No. 16/218,139, filed on Dec. 12, 2018, now Pat. No. 11,210,375.
Application No. 16/218,139 is a continuation-in-part of application No. 15/914,436, filed on Mar. 7, 2018, now Pat. No. 10,419,221.
Application No. 15/914,436 is a continuation-in-part of application No. 15/914,562, filed on Mar. 7, 2018.
Application No. 15/914,562 is a continuation-in-part of application No. 15/914,942, filed on Mar. 7, 2018, now Pat. No. 10,721,070.
Application No. 15/914,942 is a continuation-in-part of application No. 15/914,969, filed on Mar. 7, 2018, now Pat. No. 11,138,333.
Application No. 16/573,851 is a continuation-in-part of application No. 16/022,101, filed on Jun. 28, 2018, now Pat. No. 11,170,084.
Application No. 16/022,101 is a continuation-in-part of application No. 15/914,436, filed on Mar. 7, 2018, now Pat. No. 10,419,221.
Application No. 15/914,436 is a continuation-in-part of application No. 17/155,890, filed on Jan. 22, 2021.
Application No. 17/155,890 is a continuation-in-part of application No. 16/933,428, filed on Jul. 20, 2020.
Application No. 16/933,428 is a continuation of application No. 15/914,942, filed on Mar. 7, 2018, now Pat. No. 10,721,070.
Application No. 15/914,942 is a continuation-in-part of application No. 16/832,014, filed on Mar. 27, 2020.
Application No. 16/832,014 is a continuation-in-part of application No. 16/573,851, filed on Sep. 17, 2019.
Application No. 16/573,851 is a continuation-in-part of application No. 16/539,824, filed on Aug. 13, 2019, now Pat. No. 11,265,168.
Application No. 16/539,824 is a continuation-in-part of application No. 15/914,562, filed on Mar. 7, 2018.

(51) Int. Cl. G06F 21/32; G06N 3/08; G06V 40/40

(52) U.S. Cl. CPC G06F 21/32; G06V 40/45; G06N 3/08

(57) ABSTRACT

In various embodiments, a fully encrypted private identity based on biometric and/or behavior information can be used to securely identify any user efficiently. According to various aspects, once identification is secure and computationally efficient, the secure identity/identifier can be used across any number of devices to identify a user an enable functionality on any device based on the underlying identity, and even switch between identified users seamlessly all with little overhead. In some embodiments, devices can be configured to operate with function sets that transition seamlessly between the identified users, even, for example, as they pass a single mobile device back and forth. According to some embodiments, identification can extend beyond the current user of any device, into identification of actors responsible for activity/content on the device.

### RELATED APPLICATIONS

This application is a Continuation-in-part of U.S. application Ser. No. 17/560,813, filed Dec. 23, 2021, entitled “SYSTEMS AND METHODS FOR BIOMETRIC PROCESSING WITH LIVENESS”, which is a Continuation of U.S. application Ser. No. 16/218,139, filed Dec. 12, 2018, entitled “SYSTEMS AND METHODS FOR BIOMETRIC PROCESSING WITH LIVENESS”, which is a Continuation-in-part of U.S. application Ser. No. 15/914,562, filed Mar. 7, 2018, entitled “SYSTEMS AND METHODS FOR PRIVACY-ENABLED BIOMETRIC PROCESSING”. Application Ser. No. 16/218,139 is a Continuation-in-part of U.S. application Ser. No. 15/914,942, filed Mar. 7, 2018, entitled “SYSTEMS AND METHODS FOR PRIVACY-ENABLED BIOMETRIC PROCESSING”. Application Ser. No. 16/218,139 is a Continuation-in-part of U.S. application Ser. No. 15/914,969, filed Mar. 7, 2018, entitled “SYSTEMS AND METHODS FOR PRIVACY-ENABLED BIOMETRIC PROCESSING”. This application is a Continuation-in-part of U.S. application Ser. No. 17/521,400, filed Nov. 8, 2021, entitled “BIOMETRIC AUTHENTICATION”, which is a Continuation of U.S. application Ser. No. 16/022,101, filed Jun. 28, 2018, entitled “BIOMETRIC AUTHENTICATION”. This application is a Continuation-in-part of U.S. application Ser. No. 17/492,775, filed Oct. 4, 2021, entitled “SYSTEMS AND METHODS FOR PRIVACY-ENABLED BIOMETRIC PROCESSING”, which is a Continuation of U.S. application Ser. No. 15/914,969, filed Mar. 7, 2018, entitled “SYSTEMS AND METHODS FOR PRIVACY-ENABLED BIOMETRIC PROCESSING”. This application is a Continuation-in-part of U.S. application Ser. No. 17/473,360, filed Sep. 13, 2021, entitled “SYSTEMS AND METHODS FOR PRIVATE AUTHENTICATION WITH HELPER NETWORKS”, which is a Continuation of U.S. application Ser. No. 17/183,950, filed Feb. 24, 2021, entitled “SYSTEMS AND METHODS FOR PRIVATE AUTHENTICATION WITH HELPER NETWORKS”, which is a Continuation of U.S. application Ser. No. 16/993,596, filed Aug. 14, 2020, entitled “SYSTEMS AND METHODS FOR PRIVATE AUTHENTICATION WITH HELPER NETWORKS”. This application is a Continuation-in-part of U.S. application Ser. No. 17/398,555, filed Aug. 10, 2021, entitled “SYSTEMS AND METHODS FOR PRIVATE AUTHENTICATION WITH HELPER NETWORKS”, which is a Continuation-in-part of U.S. application Ser. No. 17/183,950, filed Feb. 24, 2021, entitled “SYSTEMS AND METHODS FOR PRIVATE AUTHENTICATION WITH HELPER NETWORKS”. Application Ser. No. 17/398,555 is a Continuation-in-part of U.S. application Ser. No. 17/155,890, filed Jan. 22, 2021, entitled “SYSTEMS AND METHODS FOR PRIVATE AUTHENTICATION WITH HELPER NETWORKS”, which is a Continuation-in-part of U.S. application Ser. No. 16/993,596, filed Aug. 14, 2020, entitled “SYSTEMS AND METHODS FOR PRIVATE AUTHENTICATION WITH HELPER NETWORKS”. Application Ser. No. 17/155,890 is a Continuation-in-part of U.S. application Ser. No. 16/832,014, filed Mar. 27, 2020, entitled “SYSTEMS AND METHODS FOR PRIVACY-ENABLED BIOMETRIC PROCESSING”, which is a Continuation-in-part of U.S. application Ser. No. 16/573,851, filed Sep. 17, 2019, entitled “SYSTEMS AND METHODS FOR PRIVACY-ENABLED BIOMETRIC PROCESSING”, which is a Continuation-in-part of U.S. application Ser. No. 16/539,824, filed Aug. 13, 2019, entitled “SYSTEMS AND METHODS FOR PRIVACY-ENABLED BIOMETRIC PROCESSING”, which is a Continuation-in-part of U.S. application Ser. No. 16/218,139, filed Dec. 12, 2018, entitled “SYSTEMS AND METHODS FOR BIOMETRIC PROCESSING WITH LIVENESS”. Application Ser. No. 16/539,824 is a Continuation-in-part of U.S. application Ser. No. 15/914,436, filed Mar. 7, 2018, entitled “SYSTEMS AND METHODS FOR PRIVACY-ENABLED BIOMETRIC PROCESSING”. Application Ser. No. 16/539,824 is a Continuation-in-part of U.S. application Ser. No. 15/914,562, filed Mar. 7, 2018, entitled “SYSTEMS AND METHODS FOR PRIVACY-ENABLED BIOMETRIC PROCESSING”. Application Ser. No. 16/539,824 is a Continuation-in-part of U.S. application Ser. No. 15/914,942, filed Mar. 7, 2018, entitled “SYSTEMS AND METHODS FOR PRIVACY-ENABLED BIOMETRIC PROCESSING”. Application Ser. No. 16/539,824 is a Continuation-in-part of U.S. application Ser. No. 15/914,969, filed Mar. 7, 2018, entitled “SYSTEMS AND METHODS FOR PRIVACY-ENABLED BIOMETRIC PROCESSING”. Application Ser. No. 16/573,851 is a Continuation-in-part of U.S. application Ser. No. 16/022,101, filed Jun. 28, 2018, entitled “BIOMETRIC AUTHENTICATION”. Application Ser. No. 16/573,851 is a Continuation-in-part of U.S. application Ser. No. 15/914,436, filed Mar. 7, 2018, entitled “SYSTEMS AND METHODS FOR PRIVACY-ENABLED BIOMETRIC PROCESSING”. This application is a Continuation-in-part of U.S. application Ser. No. 17/155,890, filed Jan. 22, 2021, entitled “SYSTEMS AND METHODS FOR PRIVATE AUTHENTICATION WITH HELPER NETWORKS”. This application is a Continuation-in-part of U.S. application Ser. No. 16/933,428, filed Jul. 20, 2020, entitled “SYSTEMS AND METHODS FOR PRIVACY-ENABLED BIOMETRIC PROCESSING”, which is a Continuation of U.S. application Ser. No. 15/914,942, filed Mar. 7, 2018, entitled “SYSTEMS AND METHODS FOR PRIVACY-ENABLED BIOMETRIC PROCESSING”. This application is a Continuation-in-part of U.S. application Ser. No. 16/832,014, filed Mar. 27, 2020, entitled “SYSTEMS AND METHODS FOR PRIVACY-ENABLED BIOMETRIC PROCESSING”. This application is a Continuation-in-part of U.S. application Ser. No. 16/573,851, filed Sep. 17, 2019, entitled “SYSTEMS AND METHODS FOR PRIVACY-ENABLED BIOMETRIC PROCESSING”. This application is a Continuation-in-part of U.S. application Ser. No. 16/539,824, filed Aug. 13, 2019, entitled “SYSTEMS AND METHODS FOR PRIVACY-ENABLED BIOMETRIC PROCESSING”. This application is a Continuation-in-part of U.S. application Ser. No. 15/914,562, filed Mar. 7, 2018, entitled “SYSTEMS AND METHODS FOR PRIVACY-ENABLED BIOMETRIC PROCESSING”. Each of the forgoing applications are included by reference herein in their entirety.

### BACKGROUND

Securing identification and authentication processes is a known challenge in any computing environment. Although user identifiers and password combinations are ubiquitous, their use is far from secure. Even methodologies that seek to augment known ID and passwords systems (e.g., multifactor authentication, using additional codes, etc.) have failed to fully address security concerns.

### SUMMARY

The inventors have realized that there is a need for a secure identifier that can be used to securely identify, and further used to authenticate a given user with minimal overhead and an improved security profile. In various embodiments, a fully encrypted private identity based on biometric and/or behavior information can be used to securely identify any user efficiently. According to various aspects, once identification is secure and computationally efficient, the secure identity/identifier can be used across any number of devices to identify a user and enable functionality on any device based on the underlying identity, and even switch between identified users seamlessly all with little overhead. In some embodiments, devices can be configured to operate with function sets that transition seamlessly between the identified users, even, for example, as they pass a single mobile device back and forth.

According to some embodiments, user identification can extend beyond the current user of any device, into identification of actors responsible for activity/content on the device. An example includes identification of entities leaving voice messages. In one embodiment, the system can include activity monitors that identify and process activity on a device to identify an “actor” associated with the activity. In some examples, actual identity is not needed, rather, the identification process is able to determine the same underlying actor is associated with various activities on device (e.g., multiple voice messages, as a video conference participant, appearing in photos, etc.) and provide that information to a device user. Activity identification can be linked to an identifier (e.g., a universal user identifier) that can be used across multiple devices and synchronized across online activity throughout those devices.

In still other aspects, implementation of the private identity can be employed to make any and every computing device a multi-user platform. Each user can be uniquely identified and given their own functionality on any given device. In some embodiments, mobile phone and similar devices become ubiquitous across various users based on matching a private identifier. In some examples, the private identifier need not even be linked to an underlying user identity but only has establish the unique and/or private identifier to enable such functionality.

According to one aspect a private identity system is provided. The system comprises at least one processor operatively connected to a memory, the at least one processor configured to: instantiate, at a local device, at least one pre-trained embedding network configured to generate encrypted feature vectors from an input of plaintext identifying information, instantiate, at the local device, at least one local classification network configured to accept the encrypted feature vectors and return a matching label to an identity or an unknown result during prediction, instantiate, at a remote device, at least one remote classification network configured to accept the encrypted feature vectors and label inputs to train the at least one classification network to recognize the encrypted features during training, and assign, at the remote device, a unique identifier to respective encrypted feature vectors for training the at least one remote classification network using the unique identifier as a respective label, and manage the at least one local classification network and remote classification network to output matching labels responsive to input of matching encrypted feature vectors.

According to one embodiment, the plaintext identifying information includes at least one of: biometric identifying information, behavioral identifying information, or physiologic identifying information. According to one embodiment, the at least one processor is further configured to assign, at the local device, a unique candidate identifier to respective encrypted feature vectors to return in response to geometric evaluation and for training the at least one local classification network using the unique candidate identifier as a respective label. According to one embodiment, the at least one processor is further configured to reconcile entity identification by the at least one local classification network and the at least one remote classification network such that the at least one local classification network and the at least one remote network and any geometric evaluation returns the same identity in response to processing of encrypted feature vectors associated with the same entity. According to one embodiment, the at least one processor is further configured to generate an identity profile and associate metadata information based on current device context and/or activity to a trained identity.

According to one embodiment, the at least one processor is further configured to generate an entity identity responsive to geometric matching executed on encrypted feature vectors generated from an input of plaintext identifying information for the entity and stored encrypted feature vectors. According to one embodiment, the at least one processor is further configured to store the generated encrypted feature vectors from the input of plaintext identifying information for use in subsequent geometric matching responsive to a positive match from geometric matching and by a classification network. According to one embodiment, the at least one processor is further configured to trigger training of the at least one local classification network responsive to storing of a threshold number of encrypted feature vectors. According to one embodiment, the at least one processor is further configured to define a label for identifying an entity during an enrollment and associate the label with the generated encrypted feature vectors from the input of plaintext identifying information during the enrollment. According to one embodiment, the at least one processor is further configured to: generate the label to define an identification environment, wherein generation of the label is based on at least an encryption key and unique identifier for an entity.

According to one embodiment, the at least one processor is further configured to communicate at least one encrypted feature for prediction by the at least one local classification network responsive to generating an unknown result from the geometric match. According to one embodiment, the at least one processor is further configured to request remote identification responsive to an unknown result returned by local geometric match and local prediction by the classification network. According to one embodiment, the at least one processor is further configured to return a user identifier and at least one encrypted feature vector in response to a successful remote match by either a remote geometric match or a remote prediction by the at least one remote classification network.

According to one aspect a method for private identity is provided. The method comprises: instantiating, by at least one processor at a local device, at least one pre-trained embedding network configured to generate encrypted feature vectors from an input of plaintext identifying information, instantiating, by the least one processor at the local device, at least one local classification network, accepting, by the at least one local classification network, the encrypted feature vectors and return a matching label to an identity or an unknown result during prediction, instantiating, by at least one processor at a remote device, at least one remote classification network configured to accept the encrypted feature vectors and label inputs to train the at least one classification network to recognize the encrypted features during training, and assigning, by the least one processor at the remote device, a unique identifier to respective encrypted feature vectors for training the at least one remote classification network using the unique identifier as a respective label, and managing the at least one local classification network and remote classification network to output matching labels responsive to input of matching encrypted feature vectors.

According to one embodiment, the plaintext identifying information includes at least one of: biometric identifying information, behavioral identifying information, or physiologic identifying information. According to one embodiment, the method further comprises assigning, at the local device, a unique candidate identifier to respective encrypted feature vectors to return in response to geometric evaluation and for training the at least one local classification network using the unique candidate identifier as a respective label. According to one embodiment, the method further comprises reconciling entity identification by the at least one local classification network and the at least one remote classification network such that the at least one local classification network and the at least one remote network and any geometric evaluation returns the same identity in response to processing of encrypted feature vectors associated with the same entity. According to one embodiment, the method further comprises generating an identity profile and associate metadata information based on current device context and/or activity to a trained identity.

According to one embodiment, the method further comprises generating an entity identity responsive to geometric matching executed on encrypted feature vectors generated from an input of plaintext identifying information for the entity and stored encrypted feature vectors. According to one embodiment, the method further comprises storing the generated encrypted feature vectors from the input of plaintext identifying information for use in subsequent geometric matching responsive to a positive match from geometric matching and by a classification network. According to one embodiment, the method further comprises triggering training of the at least one local classification network responsive to storing of a threshold number of encrypted feature vectors. According to one embodiment, the method further comprises defining a label for identifying an entity during an enrollment and associate the label with the generated encrypted feature vectors from the input of plaintext identifying information during the enrollment.

According to one embodiment, the method further comprises generating the label to define an identification environment, wherein generation of the label is based on at least an encryption key and unique identifier for an entity. According to one embodiment, the method further comprises communicating at least one encrypted feature for prediction by the at least one local classification network responsive to generating an unknown result from the geometric match. According to one embodiment, the method further comprises requesting remote identification responsive to an unknown result returned by local geometric match and local prediction by the classification network. According to one embodiment, the method further comprises returning a user identifier and at least one encrypted feature vector in response to a successful remote match by either a remote geometric match or a remote prediction by the at least one remote classification network.

According to one aspect a private identity system is provided. The system comprises at least one processor operatively connected to a memory, the at least one processor configured to instantiate at least one pre-trained embedding network configured to generate encrypted feature vectors from an input of plaintext identifying information, instantiate at least one classification network configured to accept the encrypted feature vectors and label inputs to train the at least one classification network to recognize the encrypted features, and accept the encrypted feature vectors and return a matching label to an identity or an unknown result during prediction, assign a unique identifier to respective encrypted feature vectors to return in response to geometric evaluation and for training the at least one classification network using the unique identifier as a respective label, and trigger a plurality of identifications of a device user during a use session, based, at least in part, on a plurality of triggering events.

According to one embodiment, the plaintext identifying information includes at least one of: biometric identifying information, behavioral identifying information, or physiologic identifying information. According to one embodiment, the plurality of triggering events include, at least, a time based trigger, periodic triggers, asynchronous triggers, or event detection. According to one embodiment, the at least one processor is configured to monitor sensors inputs from a user device to capture identifying information on the user based on proximity sensing, sensor feeds, monitoring camera input, monitoring device usage, or monitoring audio input. According to one embodiment, the at least one processor is configured to terminate a use session responsive to an unknown result or responsive to matching another user. According to one embodiment, the at least one processor is configured to identify multiple users from sensor input, and manage device access according to permissions associated with the user and any other user.

According to one embodiment, the at least one processor is configured to identify multiple users from content displayed on the device. According to one embodiment, the at least one processor is configured to obscure content displayed on the user device based on permissions associated with the any other user while identifying the user is present. According to one embodiment, the at least one processor is configured to maintain the current use session based on identifying the user and alter a display of content based on identifying another user from the plurality of identifications. According to one embodiment, the at least one processor is configured to control access to services or content on the user device based on repeated identification of the user from sensor information.

According to one embodiment, the at least one processor is configured to identify the user based on geometric evaluation of encrypted feature vectors and prediction by at least one classification network. According to one embodiment, the at least one processor is configured to return the unique identifier associated with the user responsive to a valid geometric evaluation or prediction by the at least one classification network. According to one embodiment, the at least one processor is configured to retrieve a user profile associated with the unique identifier and tailor operation of the user device according to definition in the user profile. According to one embodiment, the at least one processor is configured to terminate a first user session in response to a failed identification of the user, an unknown result, or an identification of a second user. According to one embodiment, the at least one processor is configured to retrieve a second user profile associated the second user and tailor operation of the user device according to definitions in the second user profile.

According to one embodiment, the at least one processor is further configured to return an identity responsive to geometric matching executed on encrypted feature vectors generated from an input of plaintext identifying information for the entity against stored encrypted feature vectors. According to one embodiment, the at least one processor is further configured to communicate at least one encrypted feature for prediction by the at least one classification network responsive to generating an unknown result from the geometric match.

According to one aspect a computer implemented method for private identity system is provided. The method comprises instantiating, by at least one processor, at least one pre-trained embedding network configured to generate encrypted feature vectors from an input of plaintext identifying information, instantiating, by the at least one processor, at least one classification network, accepting, by the at least one classification network, the encrypted feature vectors and label inputs and training the at least one classification network to recognize the encrypted features, accepting, by the at least one classification network, the encrypted feature vectors and return a matching label to an identity or an unknown result during prediction, assigning, by the at least one processor, a unique identifier to respective encrypted feature vectors to return in response to geometric evaluation of the encrypted feature vectors and for training the at least one classification network using the unique identifier as a respective label, and triggering, by the at least one processor, a plurality of identifications of a device user during a use session, based, at least in part, on a plurality of triggering events.

According to one embodiment, the plaintext identifying information includes at least one of: biometric identifying information, behavioral identifying information, or physiologic identifying information. According to one embodiment, the method further comprises triggering the plurality of identifications based on, at least one of: a time based trigger, periodic triggers, asynchronous triggers, or event detection. According to one embodiment, the method further comprises monitoring sensors inputs from a user device to capture identifying information on the user based on proximity sensing, sensor feeds, monitoring camera input, monitoring device usage, or monitoring audio input. According to one embodiment, the method further comprises terminating a use session responsive to an unknown result or responsive to matching another user.

According to one embodiment, the method further comprises identifying multiple users from sensor input, and manage device access according to permissions associated with the user and any other user. According to one embodiment, the method further comprises identifying multiple users from content displayed on the device. According to one embodiment, the method further comprises obscuring content displayed on the user device based on permissions associated with the any other user while identifying the user is present. According to one embodiment, the method further comprises maintaining the current use session based on identifying the user and alter a display of content based on identifying another user from the plurality of identifications. According to one embodiment, the method further comprises controlling access to services or content on the user device based on repeated identification of the user from sensor information.

According to one embodiment, the method further comprises identifying the user based on geometric evaluation of encrypted feature vectors and prediction by at least one classification network. According to one embodiment, the method further comprises returning the unique identifier associated with the user responsive to a valid geometric evaluation or prediction by the at least one classification network. According to one embodiment, the method further comprises retrieving a user profile associated with the unique identifier and tailor operation of the user device according to definition in the user profile. According to one embodiment, the method further comprises terminating a first user session in response to a failed identification of the user, an unknown result, or an identification of a second user.

According to one embodiment, the method further comprises retrieving a second user profile associated the second user and tailor operation of the user device according to definitions in the second user profile. According to one embodiment, the method further comprises returning an identity responsive to geometric matching executed on encrypted feature vectors generated from an input of plaintext identifying information for the entity against stored encrypted feature vectors. According to one embodiment, the method further comprises communicating at least one encrypted feature for prediction by the at least one classification network responsive to generating an unknown result from the geometric match.

According to one aspect a private identity system is provided. The system comprises at least one processor operatively connected to a memory, the at least one processor configured to instantiate at least one pre-trained embedding network configured to generate encrypted feature vectors from an input of plaintext identifying information, instantiate at least one classification network configured to accept the encrypted feature vectors and label inputs to train the at least one classification network to recognize the encrypted feature vectors produced by the at least one pre-trained embedding network for a plurality of identification classes, and accept the encrypted feature vectors and return a matching label to an identity or an unknown result during prediction, assign a unique identifier to respective encrypted feature vectors to return in response to geometric evaluation and for training the at least one classification network using the unique identifier as a respective label, and monitor device activity or content on a user device, capture plaintext identifying information embedded in the device activity or the content, and communicate the plaintext identifying information to the at least one pre-trained embedding network as input to produce encrypted feature vectors for identification.

According to one embodiment, the at least one processor is further configured to generate an activity profile associated with the unique identifier based on information associated with the device activity or the content. According to one embodiment, the device activity or content includes an active voice call and the unique identifier is associated with a speaker in the active voice call. According to one embodiment, the device activity or content includes an active video conference and the unique identifier is associated with a video conference participant. According to one embodiment, the at least one processor is further configured to instantiate at least one helper network configured to isolate plaintext identifying information associated with an entity from the plaintext identifying information embedded in the device activity or content. According to one embodiment, the at least one processor is further configured to instantiate at least a second helper network configured to validate the plaintext identifying information as a good sample of identifying information.

According to one embodiment, the at least one processor is further configured to return an identity responsive to geometric matching executed on encrypted feature vectors generated from the plaintext identifying information against at least one stored encrypted feature vector. According to one embodiment, the at least one processor is further configured to communicate at least one encrypted feature for prediction by the at least one classification network responsive to generating an unknown result from the geometric match. According to one embodiment, the at least one processor is further configured to access stored content associated with the user device and capture any plaintext identifying information for evaluating identity.

According to one embodiment, the at least one processor is further configured to communicate at least one of: encrypted feature vectors, unique identifiers, or trained classification networks to a remote identification service. According to one embodiment, the remote identification service is configured to execute geometric evaluation and execute prediction by at least one remote classification network, on the encrypted feature vectors to identify an entity associated with any plaintext identifying information. According to one embodiment, the remote identification service is configured to merge unique identifiers generated from a plurality of devices based on matching respective encrypted feature vectors. According to one embodiment, the remote identification service is configured to update the unique identifier at the user device.

According to one aspect a computer implement method for private identity is provided. The method comprises instantiating, by at least one processor, at least one pre-trained embedding network configured to generate encrypted feature vectors from an input of plaintext identifying information. instantiating, by the at least one processor, at least one classification network, accepting, by the at least one classification network, the encrypted feature vectors and label inputs to train the at least one classification network to recognize the encrypted feature vectors produced by the at least one pre-trained embedding network for a plurality of identification classes, accepting, by the at least one classification network, the encrypted feature vectors and returning a matching label to an identity or an unknown result during prediction, assigning, by the at least one processor, a unique identifier to respective encrypted feature vectors to return in response to geometric evaluation and for training the at least one classification network using the unique identifier as a respective label, monitoring, by the at least one processor, device activity or content on a user device, capturing, by the at least one processor, plaintext identifying information embedded in the device activity or the content, and communicating, by the at least one processor, the plaintext identifying information to the at least one pre-trained embedding network as input to produce encrypted feature vectors for identification.

According to one embodiment, the method further comprises generating an activity profile associated with the unique identifier based on information associated with the device activity or the content. According to one embodiment, the device activity or content includes an active voice call and the unique identifier is associated with a speaker in the active voice call. According to one embodiment, the device activity or content includes an active video conference and the unique identifier is associated with a video conference participant. According to one embodiment, the method further comprises instantiating at least one helper network configured to isolate plaintext identifying information associated with an entity from the plaintext identifying information embedded in the device activity or content. According to one embodiment, the method further comprises instantiating at least a second helper network configured to validate the plaintext identifying information as a good sample of identifying information.

According to one embodiment, the method further comprises returning an identity responsive to geometric matching executed on encrypted feature vectors generated from the plaintext identifying information against at least one stored encrypted feature vector. According to one embodiment, the method further comprises communicating at least one encrypted feature for prediction by the at least one classification network responsive to generating an unknown result from the geometric match. According to one embodiment, the method further comprises accessing stored content associated with the user device and capture any plaintext identifying information for evaluating identity. According to one embodiment, the method further comprises communicating at least one of: encrypted feature vectors, unique identifiers, or trained classification networks to a remote identification service.

According to one embodiment, the method further comprises executing, by the remote identification service, geometric evaluation and executing prediction by at least one remote classification network, on the encrypted feature vectors to identify an entity associated with any plaintext identifying information. According to one embodiment, the method further comprises merging, by the remote identification service, unique identifiers generated from a plurality of devices based on matching respective encrypted feature vectors. According to one embodiment, the method further comprises updating, by the remote identification service, the unique identifier at the user device.

According to one aspect, a private identity system is provided. The system comprises: at least one processor operatively connected to a memory, the at least one processor configured to: instantiate at least one pre-trained embedding network configured to generate encrypted feature vectors from an input of plaintext identifying information; instantiate at least one classification network configured to: accept the encrypted feature vectors and label inputs to train the at least one classification network to recognize the encrypted features produced by the at least one pre-trained embedding network, and accept the encrypted feature vectors and return a matching label to an identity or an unknown result during prediction; monitor device activity or content; capture plaintext identifying information embedded in the device activity or content; and communicate the plaintext identifying information to the at least one pre-trained embedding network as input; and assign a unique activity identifier to respective encrypted feature vectors generated from the communicated plaintext identifying information to return in response to geometric evaluation and for training the at least one classification network using the unique identifier as a respective label; responsive to matching the unique activity identifier display at least one function in a user interface, wherein the at least one function targets the unique activity identifier with an associated action.

According to one embodiment, the at least one processor is configured to select from a plurality of actions and identify the at least one function based on a user device context. According to one embodiment, the at least one processor is configured to determine the user device context based on at least one of: a current application being executed, a current operations being executed, content being displayed, or content being accessed. According to one embodiment, the at least one associated action includes a search function configured to execute a search through digital activity and digital content for activity and content matching a unique identifier. According to one embodiment, the at least one processor is configured to display the unique identifier in association with content returned by the search through digital activity. According to one embodiment, the at least one processor is configured to generate a display separating content that uniquely matches the unique identifier and content that includes the identifier.

According to one embodiment, the at least one associated action includes functions to block and/or deny subsequent activity associated with the unique identifier, and the at least one processor is configured to block content having the unique identifier in subsequent digital activity. According to one embodiment, wherein the at least one processor is configured to: notify a current user of a block and/or deny status; and present options to allow content or activity associated with the unique identifier. According to one embodiment, wherein the at least one associated action includes functions to assign as verified status to an actor or source associated with the unique identifier, and the at least one processor is configured to display a verified status for at least one subsequent content display showing the content associated with the verified unique identifier. According to one embodiment, the at least one associated action includes operations to add authorization for device usage, wherein the at least one processor is configured to link assigned privileges to a profile associated with the unique identifier.

According to one aspect, a computer implemented method for private identity is provided. The method comprising: instantiating, by at least one processor, at least one pre-trained embedding network configured to generate encrypted feature vectors from an input of plaintext identifying information; instantiating, by the at least one processor, at least one classification network configured; accepting, by the at least one classification network, the encrypted feature vectors and label inputs to train the at least one classification network to recognize the encrypted features produced by the at least one pre-trained embedding network; accepting, by the at least one classification network, the encrypted feature vectors and return a matching label to an identity or an unknown result during prediction; monitoring, by the at least one processor, device activity or content; capturing, by the at least one processor, plaintext identifying information embedded in the device activity or content; communicating, by the at least one processor, the plaintext identifying information to the at least one pre-trained embedding network as input; assigning, by the at least one processor, a unique activity identifier to respective encrypted feature vectors generated from the communicated plaintext identifying information to return in response to geometric evaluation and for training the at least one classification network using the unique identifier as a respective label; displaying, by the at one processor, at least one function in a user interface responsive to matching the unique activity identifier, wherein the at least one function targets the unique activity identifier with an associated action.

According to one embodiment, the method further comprises selecting from a plurality of actions and identify the at least one function based on a user device context. According to one embodiment, the method further comprises determining the user device context based on at least one of: a current application being executed, a current operations being executed, content being displayed, or content being accessed. According to one embodiment, the at least one associated action includes a search function configured to execute a search through digital activity and digital content for activity and content matching a unique identifier. According to one embodiment, the method further comprises displaying the unique identifier in association with content returned by the search through digital activity.

According to one embodiment, the method further comprises generating a display separating content that uniquely matches the unique identifier and content that includes the identifier. According to one embodiment, the at least one associated action includes functions to block and/or deny subsequent activity associated with the unique identifier, and wherein the method further comprises blocking content having the unique identifier in subsequent digital activity. According to one embodiment, the method further comprises: notifying a current user of a block and/or deny status; and presenting options to allow content or activity associated with the unique identifier.

According to one embodiment, at least one associated action includes functions to assign as verified status to an actor or source associated with the unique identifier, and wherein the method further comprises displaying a verified status for at least one subsequent content display showing the content associated with the verified unique identifier. According to one embodiment, at least one associated action includes operations to add authorization for device usage, wherein the method further comprises linking assigned privileges to a profile associated with the unique identifier.

Still other aspects, examples, and advantages of these exemplary aspects and examples, are discussed in detail below. Moreover, it is to be understood that both the foregoing information and the following detailed description are merely illustrative examples of various aspects and examples and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF THE DRAWINGS

Various aspects of at least one embodiment are discussed herein with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. Where technical features in the figures, detailed description or any claim are followed by references signs, the reference signs have been included for the sole purpose of increasing the intelligibility of the figures, detailed description, and/or claims. Accordingly, neither the reference signs nor their absence are intended to have any limiting effect on the scope of any claim elements. In the figures, each identical or nearly identical component that is illustrated in various figures is represented by a like numeral. For purposes of clarity, not every component may be labeled in every figure. In the figures:

FIG. 1 is a dual neural network construct for using a private identity, according to one embodiment;

FIG. 2 illustrates a dual neural network architecture with filtering networks, according to one embodiment;

FIG. 3 illustrates a local and remote identity model, according to one embodiment;

FIG. 4A is an example process flow for identification, according to one embodiment;

FIG. 4B is an example process flow for identification, according to one embodiment;

FIG. 5 is an example process flow for remote identification, according to one embodiment;

FIG. 6 is an example user interface showing actor identification and display, according to one embodiment;

FIG. 7 is an example user interface showing identification display, according to one embodiment;

FIG. 8 is an example universal identification flow, according to one embodiment;

FIG. 9 is a block diagram of a conceptual organization of user identity, according to one embodiment;

FIG. 10 is an example user interface showing identification operations and display, according to one embodiment;

FIG. 11 is an example user interface showing identification operations and display, according to one embodiment;

FIG. 12 is an example user interface showing identification operations and display, according to one embodiment;

FIG. 13 is an example user interface showing identification operations and display, according to one embodiment;

FIG. 14 is an example process flow for enrolling in a privacy-enabled identification system, according to one embodiment;

FIG. 15 is an example process flow for classifying encrypted feature vectors, according to one embodiment;

FIG. 16 is a block diagram of an example classification network, according to one embodiment;

FIG. 17 is a block diagram of an example identification system, according to one embodiment;

FIG. 18 is a block diagram of example helper networks, according to one embodiment;

FIG. 19 is a block diagram of an example computer system that can be specially configured to execute the functions, algorithms, and/or operations disclosed herein to improve the computer system;

FIG. 20 illustrates example processing for detecting presentation attacks, according to some embodiments;

FIG. 21 illustrates example process flow for voice processing, according to some embodiments;

FIG. 22 illustrates example process flow for facial image processing, according to some embodiments;

FIG. 23 illustrates example process flow for fingerprint processing, according to some embodiments; and

FIG. 24 is a block diagram of an example system, according to one embodiment.

### DETAILED DESCRIPTION

According to various embodiments, efficient and small computing form factor neural networks can be implemented on various computer devices to control and manage user identity. Various functions are made available on such devices that are enabled by validating a user (e.g., identifying the user), even in some examples, without knowledge of the underlying identity of identified users. Conventional computer systems and conventional computer operations typically start with a known user (and known identity) and assign the known user identification credentials and/or authentication credentials. In various embodiments, private identification networks are configured to identify users without needing underlying identification information. This capability enables secure functionality unavailable in conventional computing settings. Moreover, compared to traditional settings, private identification improves the security of known approaches, enabling the private and secure use of biometric and/or behavioral identification information.

According to some embodiments, a private identity system can be used to identify a common source (even if the source is itself anonymous or unknown) of digital activity. The identified source can likewise be identified on various devices enabling full linkage of that source's online activity. While many systems have attempted to perform activity tracing, the private identity system can process and link information sources that conventional approaches cannot handle using private identification.

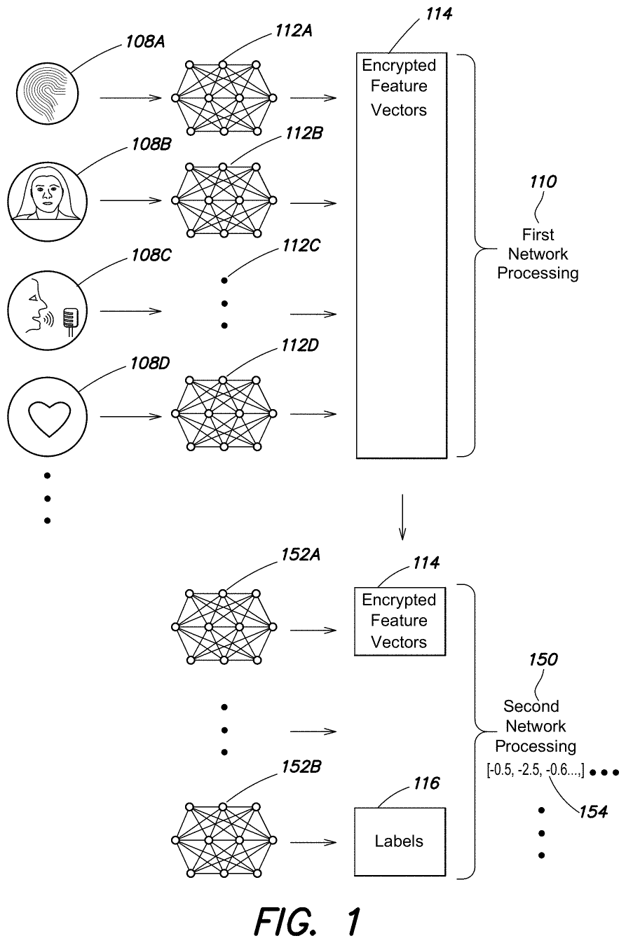

FIG. 1 illustrates a dual neural network construction configured to validate user identity. According to various embodiments, a first neural network (e.g., 112A-112D) is configured to generate feature vectors or embeddings (e.g., 114) from a plaintext (unencrypted) input (108A-D) during processing by any or all of the first neural networks (e.g., at 110 first neural network processing). According to various embodiments, the first neural networks are pre-trained networks. In one example, the first networks can be pre-trained on a variety of identifying information, including for example, biometric and/or behavioral information. In some examples, a multitude of first networks are pre-trained with respect to types of input, where the information type can be based on a type of authentication input (e.g., biometric, fingerprint, facial image, voice sample, audio sample, biometric readings (e.g., heart rate, EEG scan, pulse, respiration, ambulation, etc.), as well as behavioral information, among other options). Co-pending U.S. patent application Ser. No. 17/492,775 filed on Oct. 4, 2021 describes various neural networks and examples of pre-trained networks used to support building user identities by producing encrypted feature vectors, which is incorporated by reference herein. In some of the examples, described are neural networks configured to generate fully encrypted embeddings or fully encrypted feature vectors.

In various embodiments, a second neural network (e.g., 152A-B) is configured to train and subsequently predict on the fully encrypted feature vectors/embeddings (e.g., 114) produced by a respective first neural network during second network processing at 150. A multitude of respective second neural networks can be instantiated and linked to the multitude of first networks, and each pair can be tailored to process various types of input and produce an identification output during second neural network processing at 150. In some embodiments, first and second is used to delineate network function—create encrypted feature vectors or embeddings, first network, and classify encrypted feature vectors, second network. In such examples, order of network designations is not relevant, rather the difference in function is being highlighted by the designation to facilitate understanding of the two classes of neural networks.

According to some embodiments, the second neural network is provided a label (e.g., 116) and embeddings from the first neural network to train a respective second network. Input of embeddings post training allows the second neural network to return a matching label if a known input is given or an unknown result where an unknown embedding input is provided (e.g., at 154). In some examples, the second network can be configured to output an array of values, and the numbers in the array can reflect a degree of match to a trained label. Various thresholds can be set to determine a valid match to any label.

According to various embodiments, a unique and arbitrary label can be used to train the second neural network to recognize any embeddings. For example, even where the entity/actor is unknown, the second neural network can link any embeddings input to the arbitrary label, enabling identification of users (even unknown) and their respective activity. In some embodiments, a central component or central remote server functions to assign universal identifiers for use as labels. In some embodiments, the remote server can be configured to manage and reconcile universal user identifiers (UUIDs) across any connected devices. In still other embodiments, the remote server can be configured to manage embedding/identifier linkages even across various security platforms that maintain their own linkage between a UUID and underlying identities. In further embodiments, these identifiers can be combined with other value to define authentication environments or silos. For example, encryption keys (e.g., API keys) can be linked to the identity and/or combined into a unique identity allowing various identifiers to be tailored and used in specific identification environments, applications, within organizations, etc.

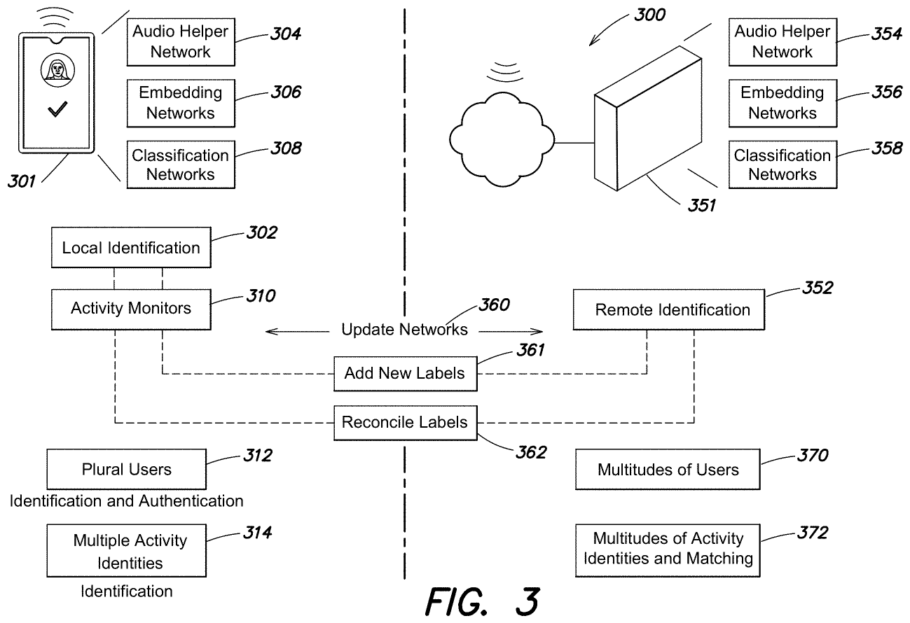

In some embodiments, the respective user does not need to be known at all, and still any activity on a device can be linked to a respective label with confidence and/or a validated identity. In further embodiments, the UUID is maintained as an anonymous identifier and encrypted embeddings can be used by a server or remote systems (see FIG. 3) to merge activity and identifications across any number of devices. To the inventor's knowledge, this is the first implementation of completely accurate and private identification that is operable at internet scale.

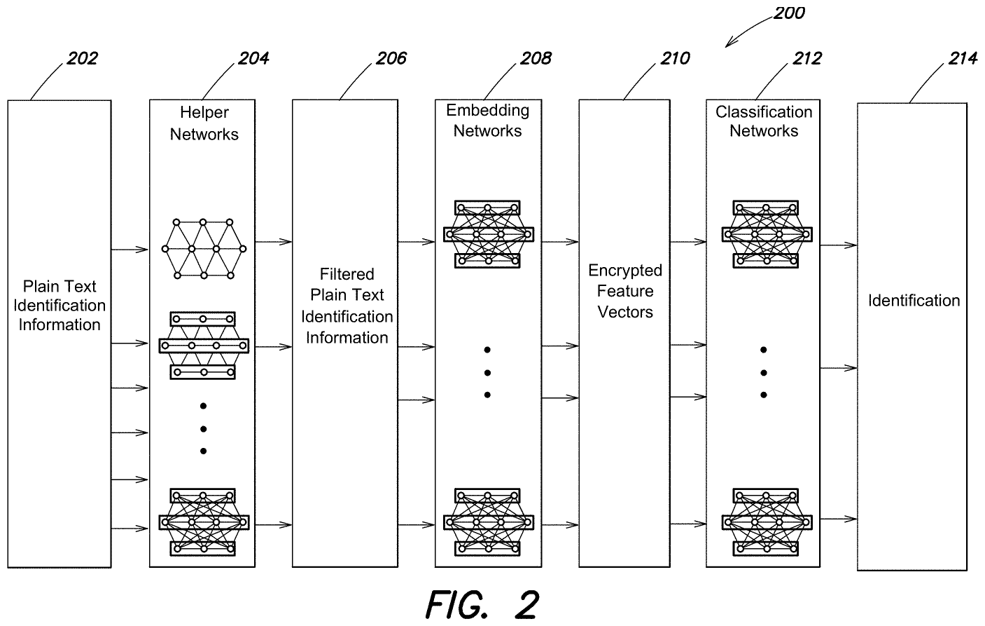

FIG. 2 is a block diagram of an improved identification architecture 200. According to various embodiments, plaintext identification information 202 (e.g., behavioral, biometric, physiologic, and/or digital activity based information, among other options) can be processed by helper networks (e.g., 204) that are configured to protect embedding networks (208) that generate encrypted features vectors (210). In various settings, helper networks (204) protect embedding networks (208) by ensuring that only good identification data is used (206) to construct encrypted feature vectors (210) used to train classification networks (212) that allow identification (214). Various helper networks are described in co-pending U.S. patent application Ser. No. 17/473,360 filed on Sep. 13, 2021 that are configured to identify good identification data, incorporated by reference herein.

According to various embodiments, helper networks are configured to recognize good identification data and/or recognize bad identification data, where good identification data improves the identification entropy of the resulting feature vectors when used to train classification networks. For example, helper networks are configured to identify spoofed identification data. Spoofed identification can include captured video of a subject replayed for facial recognition or a captured photo represented for facial recognition. Various example helper networks are configured to recognize presentation attacks in various forms. From a high level perspective, when bad identification data is used to build encrypted feature vectors and subsequently train classification networks, the accuracy of the entire system is reduced. Thus, filtering bad data from subsequent use protects the identification system and yields improved accuracy. Other examples of bad data include blurry images, poorly cropped images, multiple indistinct subjects in a sample, bad audio capture, too much noise, among many other options. Helper networks are trained on good and bad data samples to validate good samples and filter bad samples.

According to other embodiments, liveness can be validated with capture of identification information by helper networks. Liveness describes the condition to test whether the user has actually submitted the identification information being processes and done so contemporaneously with the request/submission of identification information. In various embodiments, bad identification data can be filtered (206) before the identification information is used for generating encrypted feature vectors at 210 and classification networks are trained. In other embodiments, good identification data can be validated to produce filtered plaintext identification information at 206. By filtering and/or validating the plaintext identification information, the accuracy and durability of the classification networks is preserved.

According to another embodiment, once secure and private identification is enabled by the system, various architectures extend the identification capability into analysis across a variety of devices and seemingly disparate actions and/or activity. FIG. 3 is a block diagram of a local and remote components of a private identity system 300. Local in this context is based on being at or proximate to a device where plaintext identifying information is being captured for identification. Show in FIG. 3 is an identification system that integrates local identification functions (e.g., 302) and remote identification functions (e.g., 352) to establish the private identity system 300. According to some embodiments, each of the identification functions (local and remote) can be used to establish, train, and/or update (e.g., 360) neural networks (304-308 & 354-358) that are configured to generate private identification. The neural networks can then be synchronized in the local and remote settings. In some embodiments, new labels and/or encrypted feature vectors can be communicated from local to remote and vice versa allowing classification networks to be trained on the new label (e.g., 361). In some alternatives, a “new” local label and embeddings can be communicated to the remote server 351, which identifies an existing match to the same embeddings. In this example, the labels are reconciled (e.g., 362—merged label, retrain network, link label, or distribute classification network with exiting label, etc.) across the system and the networks updated accordingly.

For example, encrypted embeddings can be created on an “unknown” actor. In the local setting, the unknown actor can be added with a unique activity label, so that all actions by the same actor (who may remain anonymous) on that device can be identified as being done by that actor. For spam or phishing activity, this is a powerful tool as the actor will be identified, for example, by voice regardless of what contact information changes from time to time or attempt to attempt. For example, the remote identification services can use the various identifications produced locally at a multitude of devices to define neural networks on a multitude of users, and multitudes of activity identities (e.g., 370 and 372). Likewise, an actor who the device owner interacts with regularly (but has no contact information), can still be identified as a known entity or actor based on matching embeddings. The same activity actor can be identified by their private biometrics (e.g., encrypted embeddings) even where that entity or actor is connecting with the device owner from a different unknown phone number or when using a known phone number belonging to someone else. In yet another example, the system can still identify that actor when their originating device is actively blocking identification information because, for example, they leave a voice message, and the system creates encrypted feature vectors from the recording and classifies those encrypted feature vectors as a match.

As shown in FIG. 3, the local devices (e.g., 301) are configured with neural networks that perform identification based on executing neural networks (e.g., 304-308). Local identification can be executed to identify a user of a given device 301 with one or more neural networks executing at the device. Each entity who uses the device 301 can be identified with the local identification functions (e.g., 302) that have helper networks 304 to ensure good identification data is used, embedding networks 306 configured to generate encrypted feature vectors/embeddings from the identification data, and classification networks that match the embeddings to identities. For example, a camera on the device captures plaintext facial information (e.g., face image). The helper networks can ensure that the image capture generates a good information sample of the face image, which is then communicated to the embedding networks (e.g., 306) that produce encrypted feature vectors for classification (e.g., by 308). Typically, the plaintext data is deleted upon creation of the encrypted feature vectors preserving privacy.

As the entities using the device change, the device can be configured to provide different operations, levels of access, etc., which can be tailored to the respective user identified by the private identity functions. In one example, an administrative user can be given the authority to define what functions a group of users (e.g., 312) are given access to, including the ability to assign or remove functionality for various user/identities. Each time new identification samples are detected on the device (e.g., new user of the device and/or new activity on the device), the local identification functions (302) will attempt to identify the new user (which can include continuously verifying the identity of the current user) and/or various activity monitors will review digital activity on the device and attempt identification of the actor associated with the digital activity (e.g., 314).

A local activity monitor can be executed on the device (e.g., 301) to detect digital activity. The activity monitor is configured to access new activity and use the new activity as input into the local identification functions 310. In one example, a new voice message may be received on the device, and the activity monitor (e.g., 310) can process the received message as an audio input to an audio helper network 304 that validates a good identification sample (e.g., voice recording). The validated audio can then be processed by an audio embedding network to produce encrypted feature vectors, which can be used to identify an actor associated with the audio by an associated classification network (assuming the network has been trained to identify the actor). In another example, an active phone call can be identified and processed through the identification functions. In one embodiment, the activity monitor is configured to capture voice information from an active phone call to generate an identification of the speaker (or even speakers in a conference call). In another embodiment, the activity monitor is configured to identify a voice conference, capture video, images, and/or audio for processing by the identification functions.

In various embodiments, the identification system can be used to identify actors or entities associated with various digital activity, in this example, to identify a source entity for the voice message. Other activity including video chat, Zoom meetings, twitch streams, etc., can be processed by activity monitors, which can confirm the identity of each actor within the content. While the actor as a source can be identified, the system can also operate where the identity information for the actor is unknown, and the system matches the voice to a unique and/or anonymous label. In various embodiments, additional processing may be done to build or associate information on the underlying actor or entity. In the voice message context, transcription of the voice message may identify the caller—“Hi, its Mike . . . ”. That information can be associated with the label and encrypted feature vectors, but may require confirmation. In another example, for a voice conference, calendaring information may be captured and linked to an identity profile. Further, the system can identify and flag instances where the same voice uses different identifying information as suspect, or potential fraud. When this identifying capability is extended via the remote identification services (e.g., 352), the ability to identify an actor (even if anonymous) is multiplied by each and every connected device as the various helper, embedding, and classification networks (e.g., 304-308 and 354-358) are updated.

In further embodiments, multitudes of users and user devices can be enrolled with any number of remote systems, and the private identification system 300 and associated neural networks can identify any unique activity that occurs on any of the devices connected to the remote identification server (352). The remote identification server can also include helper networks 354 to ensure good information samples, embedding networks 356 to produce encrypted feature vectors, and classification networks to classify encrypted feature vectors or train to classify encrypted feature vectors. According to some embodiments, the remote server 351 is configured to operate on encrypted feature vectors provided by the local identification devices to link the encrypted feature vectors to an identifier/label.

In some embodiments, each of the local devices (e.g., laptop, desktop, mobile, etc.) and the remote servers can include helper networks, embedding networks, and classification networks and device 301 and remote server 351 are shown as examples that can be duplicated, connected, and scaled to any degree. In further embodiments, the system 300 can be executed by various entities and represent various identification and/or authentication environments. In some alternatives, the system 300 and/or remote identification can be called from various authentication environments already in place. In already existing installations, local identification services can be downloaded to the devices in the existing installation based on networks trained by the remote server 351. In further embodiments, the existing security system can call for identification operations as a service, for example, through an API and/or secure connection.

Updating of identification may be executed across any number of devices in an authentication environment, and may even be done between multiple authentication environments. Notably, encrypted embeddings are one way outputs of the embedding networks (e.g., 306 and 356) that cannot be reversed, thus sharing of encrypted embeddings and even unique/anonymous labels allows for improved identification functions without compromising underlying identity information. In various examples, updating of identification information can invoke communication of encrypted embeddings and unique labels, so that the new labels can be added to remote networks, and the updated remote networks propagated to connected devices.

Generation of labels and linking of identity can also include identification environments that establish boundaries for an identification. For example, a corporation may have many identification environments based on different user populations, privileges, access rights, etc. Each environment can thus be used to define specific user groups, specific privileges, specific access rights, and any combination thereof. In some embodiments, the identification system can be used to provide validation of identity, and an entity may use that validation to control their own identification environments based on the validation of identity (and for example, returned user ID). As the system can be configured to validate identity and return any arbitrary unique user ID, the system can be configured to map UUIDs to any value usable by an entity seeking to perform identity validation. Mapping can be accomplished as part of training a neural network on a label (e.g., the neural network will then output the UUID on input of encrypted feature vectors), or by returning a label value and mapping the label value to a UUID that the system can communicate to the entity.

In some embodiments, labels/UUIDs can be generated in conjunction with or based on encryption keys. For sets of labels that are associated with a specific key or keys, the system can manage an identification/authentication environment based on such keys. According to one embodiment, the encryption key can be based on an API key communicated to the system by an entity subscribing to identification services or as provided to the subscriber via an API and associated key. By linking any identity generated from encrypted features vectors to an API key, the system can return a UUID that incorporates or encodes keys usable by the identification/authentication client. The response in such settings can be used by the subscriber to validate the returned UUID. In other settings, the system can return a valid match indicator to subscribers directly, and may include the UUID. The generation of UUID can include randomly generated values, increasing values, and may be combined, hashed, and/or merged with other values, including encryption keys. In various embodiments, changing the key and thus the UUID for a security environment enables the system to decommission old security information in favor of new UUIDs. In various embodiments, the change can require retraining of classification networks on the newly formulated UUIDs. In various alternatives, a mapping can be changed to reflect new security information (e.g., keys). In still other embodiments, the system can manage multiple security environments, even for the same subscriber. For example, the subscriber can establish authentication settings based on different security keys or other security value, and the system can return UUIDs reflecting the same. In one example, the system can establish a global user identifier for an identity. The global user identifier (“GUID”) is generated by the system in response to any identification request and execution (e.g., local geometric evaluation, remote geometric evaluation, local classification network, remote classification, etc.). The GUID can be mapped to a UUID used by requesting entities or systems, and in some examples, returned. As discussed above, the mapping can be to encryption keys associated with the requesting entity or combined user identifying values and key combinations. In some alternatives, the role assigned to the GUID and UUID can be reversed.

In other examples, the remote servers receiving encrypted embeddings and/or labels can reconcile identification information to eliminate duplicates, merge labels, etc. In further embodiments, the remote server can be configured to manage universal user identifiers across any connected devices. In some settings, the remote server is used as the enrollment source, meaning only the remote server initially assigns user ids to avoid reconciliation issues, conflict issues, and/or update issues. In other embodiments, local and remote assignment is allowed, and the remote servers manage updates, merges, and conflict resolution for UUIDs.

In various implementations, the remote identification can encompass many more identities than provided at a local device. In some embodiments, user identification functions are maintained separately from activity identification, and can include separate networks for activity and users. In such settings, activity can be processed by user networks first then activity networks can be checked, or in various alternatives parallel execution can occur. In such settings, the limitation on size of the user identification networks enables smaller and faster networks for user identification and/or authentication. Further, separation of the activity identification networks can be used to allow activity identification to take longer periods of time without impacting user identification or performance of universal device operation, for example, by a group of different users. In some activity identification settings, the identification can be executed in the background or even offline on a remote server to avoid saturating processing with identification operations.

In further embodiments, the system can be configured to execute helper networks for detecting and differentiating input provided by a human or machine. In some embodiment, the system can be configured to augment web or Internet applications for verifying that data originating from a source is from a human, and not from an unauthorized computer program/software agent/robot. As discussed herein, a helper network can be configured to evaluate camera input to determine a valid biometric of user's face (e.g., therefore is not a robot or spoof). Further helper networks can be configured to analyze video input to protects against video presentation attack (PAD), allowing validation of a live user. Other helper networks can be implemented alone and/or in any combination with any other helper network: image evaluation DNN configured to protect against image presentation attack (PAD) based on image input; geometry evaluation DNN configured to finds valid biometric (e.g., a face) in image data; blurry image evaluation DNN configured to determine a biometric is not too blurry from input image data; mic input evaluation helper network configured to determine valid biometric input of user's voice (e.g., live input, and therefore is not a robot); voice spoofing evaluation DNN configured to protect against deepfake or recorded audio attack; validation helper network DNN configured to find valid human voice in input data; random sentence helper network is configured to display a random sentence, then use an automatic speech recognition (ASR) DNN to convert speech to text to ensure a human said the requested words, among other helper network options.

Various embodiments are configured to detect and differentiate input provided by humans and machines using targeted helper networks. One or more helper networks can be used to make a determination of live human versus other submission (e.g., bot, spoof, etc.). For example, the system can be configured for web bases applications and/or services, or Internet applications, to verify that data originating from a source is from a human, and not from another source. According to one aspect, the system can be configured to validate a source of image data input to a computing system comprising: receiving one or more images, processing the images using helper networks to ascertain the validity, and generating a determination of whether the face images originated from a machine or a human. According to another aspect, the system can be configured to validate a source of audio data input to a computing system including: receiving speech utterance from a microphone that (optionally) read out loud a randomly selected challenge text; processing the speech audio with helper networks to ascertain the validity (via helper network), and generating a determination of whether the audio images originated from a machine or a human.

Some embodiments include operations for: granting or denying access to data and/or a data processing device based on the results of the live human determination above, which can be used to implement a completely automated public Turing test to tell computers and humans apart (“CAPTCHA”). In one example, a helper network based CAPTCHA can include a signup for an email account or a blog posting. In other examples, the system can implement function for granting or denying access to an electronic or other data objects (e.g., advertisement, song, digital rights controls, permissions, access rules, etc.) based on the determination performed. Other embodiments can execute an automated visual challenge test (e.g., alone or in combination with other validations) so that both visual processing and articulation processing is considered in one or more of the determinations.

In further embodiments, validation of human users can be used any one or more of the following: a) establishing an online account; and/or b) accessing an online account; and/or c) establishing a universal online ID; and/or d) accessing a universal online ID; and/or e) sending email; and/or f) accessing email; and/or g) posting on a message board; and/or h) posting on a web log; and/or i) posting on a social network site page; j) buying or selling on an auction site; and/or k) posting a recommendation for an item/service; and/or l) selecting an electronic ad.

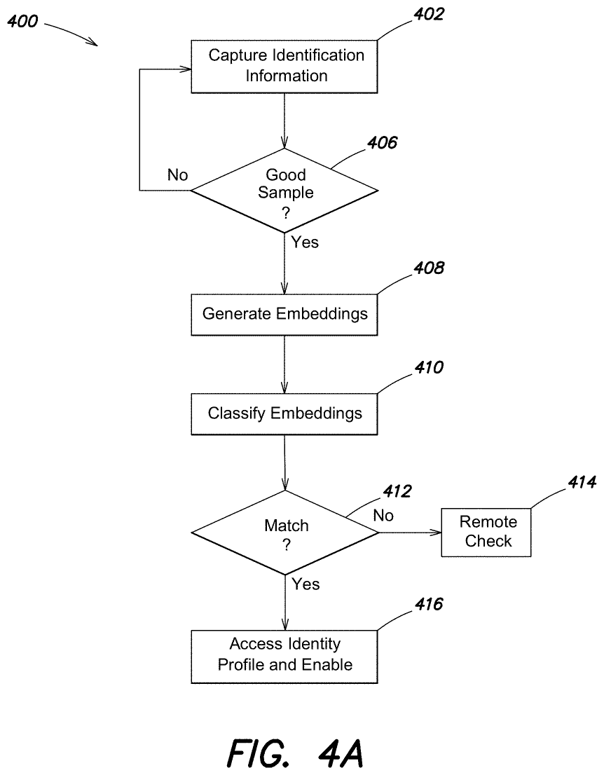

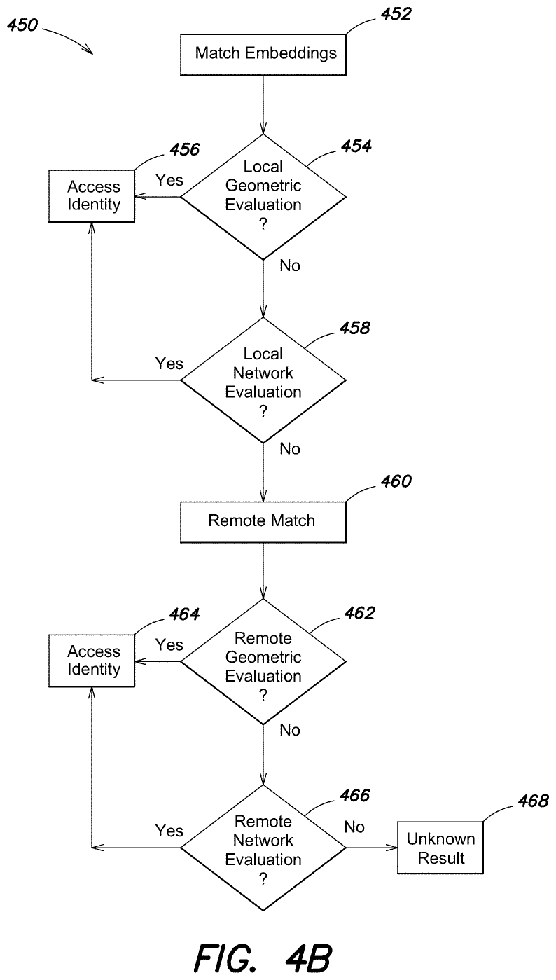

In FIG. 4A shown is an example process flow 400 for user identification. Process 400 begins with capture of identification information at 402. For example, when a user picks up their mobile device, step 402 can include image capture on a user attempting to access the device. In some embodiments, a user interface can be displayed to facilitate capture of an image of the user's face. Other biometric and/or behavioral information can be captured for use in identification (e.g., audio sample, positioning of device, health sensor data, etc.).

Process 400 can continue at 404 with analysis on whether the identification information is a good sample. Helper networks are configured to process identification information as an input and validate a good information sample. Here, a good sample is identified based on trained network characteristics where the helper network is trained to identify information samples that will improve identification entropy of subsequent neural networks. This can include training to identify spoofed identification information (e.g., photo of a user held up to the camera, etc.).

If the identification information is not good, 404NO, process 400 can return to 402 to make another capture or attempt. In one example, this flow occurs where “not good” is identified as a bad capture versus identifying a presentation attack. With a presentation attack various security responses (not shown) can be triggered. If the identification information is validated as a good sample, 404YES, process 400 continues with generation of encrypted feature vectors/embeddings at 408. The embeddings are then classified at 410 to determine any match to an identity. If there is no match locally (i.e., the classification neural network is not trained to identify the embeddings), at 412NO, process 400 can continue with a remote identification attempt at 414 using the embeddings. If there is a match returned by the classification network, 412YES, then process 400 continues with access to the identity, any profile associated with it, and enabling any functionality specified in the profile at 416. In various embodiments, the device can also include functions, settings, and/or customizations that are associated with any identified user, as well as setting specific to groups of users, and/or authenticated users, that may be triggered as well and/or in the alternative.

Process 400 can be executed on a device as a continuous identification function. In some embodiments, the identification by a local neural network can take place in less than 0.1 seconds, enabling users to pass the device between them and access their own functionality, customization, etc., seamlessly as the device is transitioned between users. Even where a local identification attempt returns an “unknown” result and remote identification is triggered, the device can execute functions to label the unknown embeddings as a guest user, who can then be recognized subsequently. Such an approach can work in an offline mode as well as where the remote identification returns an unknown result. While in some examples the guest may not be given the same permissions, the device can now recognize the guest user any time their identification information is captured based on training a classification network on the unknown embeddings. Similarly, process 400 can be used by activity monitors that capture identification information from digital content and/or digital activity on a device and pass that information to step 402.

According to various embodiments, execution of helper networks can be limited in some instances with respect to digital activity on a device. For example, helper networks configured to detect spoofing or presentation attacks can be triggered because of the nature of the digital activity. In one example, a voice recording or voice mail would normally be filtered as a submission of identification information that is not live or that may be a fake presentation of identification information. These restriction and/or filters are loosened in the context of analyzing digital activity where the digital activity is not presented as a live capture of identification/authentication information. In some embodiments, the helper networks can be limited to analyzing the digital activity to ensure that it is a good information capture. In still others, the determination is used as advisory, permitting “bad” information to be used to permit identification on digital activity, but flagging such data or isolating such data to prevent its use in updating other neural networks. In some embodiments, the good data threshold for analyzing the identification data can be reduced to permit more data to be evaluated and/or used by the embedding and classification networks in the context of identifying actors associated with digital content. In other embodiments, the data and/or resulting embeddings/label may be flagged so that the system reports on a possible or likely match as opposed to a match made on good identification data. In still other embodiments, low threshold networks can be implemented and updated to identify source actors for data used with a lower threshold. In some examples, low threshold networks can be maintained separately from higher threshold/accuracy networks, and can be used concurrently, in parallel, or in any combination.

According to some embodiments, identification can be based on a number of pathways. For example, process 400 describes an approach for determining identity based on executing local and remote checks of identity. Shown in FIG. 4B is another example process 450 for resolving identification. According to some embodiments, process 450 can be executed as an alternative pathway to that shown in process 400. For example, process 400 may stop at 408 and continue with the process shown in FIG. 4B. Other approaches can be configured to execute process 450 once any embeddings are created from an identification information input (e.g., plaintext biometric information input to a neural network).

Shown in FIG. 4B, is the example process 450. Process 450 begins at 452 with an attempt to match generated embeddings to an embedding stored by the system. At 454 a local geometric evaluation is executed to determine if a currently created embedding matches any enrolled embedding. In some examples, local refers to an evaluation that occurs on a device that captures the identifying information to be processed. In other examples, local refers to distributed identification on devices/systems proximate or associated with the user to be identified. In still other examples, local can refer to devices that communicate with a central service or system that hosts a remote identification repository.

According to some embodiments, geometric evaluation involves direct comparison of one or more embeddings to one or more stored or enrolled embeddings. If currently input identification information generates embeddings that match a stored embedding (e.g., 454 yes) the identity associated with the stored embedding is retrieved (e.g., 456) and used for the current identification. According to various embodiments, a match can be generated based on evaluating a Euclidean distance between the currently generated embedding and a stored embedding. In other embodiments, the generated embedding can be compared using a cosine measure or squared distance measure, among other options. The approach used to evaluate whether a generated embedding matches a stored embedding can depend on the input identification information and resulting embedding or encrypted feature vector. For example, image data is often susceptible to Euclidean distance evaluation, where audio data used to generate embeddings may be evaluated on cosine similarity, amongst other options.

As shown, if the local geometric evaluation at 454 fails (e.g., 454 know), process 450 continues with a local network evaluation at 458. According to some embodiments, local network evaluation of 458 includes processing of a generated embedding by a classification network. For example, a generated embedding is input into a classification network to determine a matching label or unknown result. If there is a matching label (e.g., 458 yes), the identity is accessed at 456 and the current user is identified. As discussed herein, identity can be associated with an identity profile that contains information and/or context for specific identity. The information and/or context can be used to customize a device being operated, customize features being presented, map to authentication information, map to permissions, among a host of other options. If the local network evaluation of 458 returns an unknown result (e.g., 458 no), process 450 continuous with a remote match at 460.

According to some embodiments, various devices can be connected to a central identification service or server that can maintain additional identification information. According to one embodiment, process 450 includes an identification request executed against a remote system at 460. In some embodiments, remote match includes a remote geometric evaluation of generated embeddings. As part of attempting a remote match (e.g., 460), a local device can communicate one or more generated embeddings to a remote service or repository to attempt identification. Similar to 454 above, geometric evaluation of 462 includes comparison of a generated embedding (communicated as part of the remote identification request) to when enrolled or stored embedding at the remote location. Upon match (e.g., 462 yes) identity can be accessed at 464. According to some embodiments, if there is a match the matching user id can be returned, and can be accompanied, by at least one matching embedding. The matching embedding can optional be stored at the device requesting identification (e.g., local device). If there is no match (e.g., 462 no), process 450 continues with a remote network evaluation of identity. Here the embedding communicated to the remote service is input to a trained network to return a label on match—upon matching the identity is accessed at 464, and can be the matching label. According to some embodiments, if there is a match the matching user id can be returned, and can be accompanied, by at least one matching embedding. The matching embedding can optional be stored at the device requesting identification (e.g., local device). If there is no match (e.g., 466 know), then an unknown result is returned at 468.

Various embodiments can handle unknown results differently. For example, an unknown result on a local device can trigger a remote match request (e.g., 460). In some alternatives, an unknown result on the local device can trigger an enrollment process and the currently generated embedding can be linked to a universal identifier or label for subsequent identification. According to some embodiments, geometric evaluation is used for initial identifications of a user or entity. At each evaluation/generation of and embedding, the generated embedding is stored for evaluating subsequent identification attempts. According to some examples, when a number of embeddings are stored a classification process can be triggered. In one example, once a sufficient number of embeddings are generated those embeddings can be used to train a classification network, and the classification network can be used for any network evaluation (e.g., 458).

According to some embodiments, a device can include thresholds to determine when a sufficient number of embeddings have been stored. In one example, a device can trigger training of the classification network responsive to storing hundreds of embeddings (e.g., 100, 150, 200, 250, etc.). Responsive to training the classification network the stored embeddings can be cleared from memory. In further embodiments, embeddings can be stored on a local device and communicated or synchronized to a remote server. The remote server can have different thresholds for training classification networks and may retain stored embeddings even after training of the classification network.

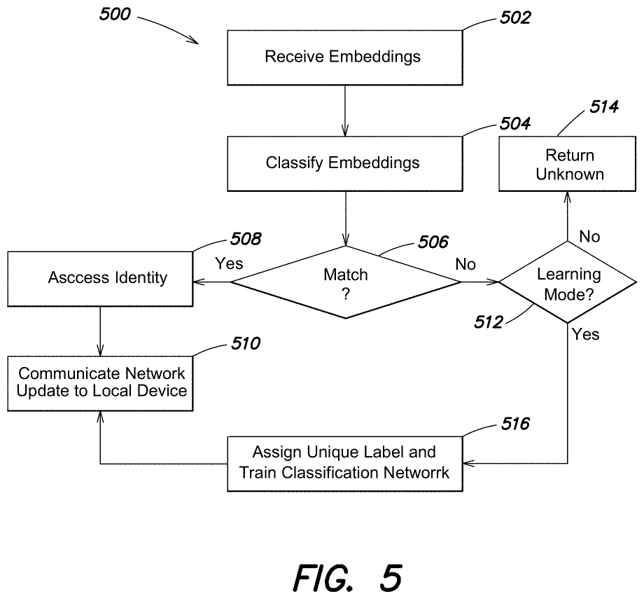

FIG. 5 is an example process flow 500 for invoking remote identification. Process 500 can be executed in response to an unknown result from a local identification attempt (e.g., from 414 of FIG. 4). Process 500 can begin at 502 with receipt of encrypted feature vectors/embeddings. In some embodiments, local identification functions are configured to generate encrypted feature vectors as part of local identification, and in response to returning an unknown result communicate those feature vectors for remote processing. Process 500 continues at 504 with classification of the feature vectors. In various embodiments, one or more classification neural networks has been trained on encrypted feature vectors. If there is a match to an identity, 506YES, the classification network generates a match to label which corresponds to an identity. The process 500 continues with access to the identity at 508 and capture of any identity profile information. At 510, process 500 communicates the identity, any profile information, and can also communicate an updated classification network that can be installed and used at the local device to enable local identification of matching encrypted feature vectors. In the case where the classification network returns an unknown result 506NO, the process can either return the unknown result at 514 if a learning mode is not enabled 512NO, or can update the classification network by assigning a unique label and training the classification network on the label and received encrypted feature vectors at 516. Once an update to the classification network is complete, the updated network can be communicated to a local device from which the encrypted feature vectors were received. Updating operations can be extended throughout connected devices so subsequently each local device can identify users and/or activity corresponding to the unique label locally.

If there is match on the encrypted feature vector 506YES, process 500 can continue with access to the matched identity and any associated profile information at 508. The local device communicating the encrypted feature vectors may be updated to be able to identify the identity at 510. For example, the classification network executing at the remote location can be communicated to the local device for subsequent matching.

Various embodiments implement different options for updating and/or synchronizing local neural networks. In some embodiments, user identification and activity identification are performed by individual networks tailored to the respective identification information. In other embodiments, the system and/or local device can maintain separate identification networks for identifying device users versus neural networks for identifying actors associated with digital activity on respective devices. Similarly, network synchronization between local devices and remote servers can be tailored to usage, respective devices, security settings, the type of network (e.g., user or activity), the identification functions being performed, volume of requests for a specific identity (e.g., low use identification may be maintained only on remote server, etc.), user identification versus activity identification, among other options.

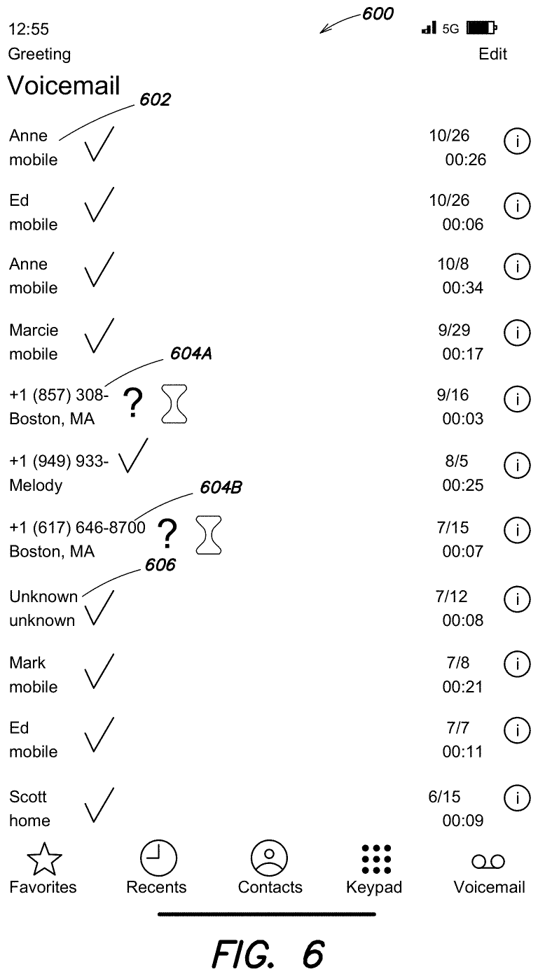

FIG. 6 is a screen capture of a user interface 600 for displaying identification information. As discussed above, activity monitors can be configured to capture activity on a device, including for example, a mobile phone. The activity monitors can capture and communicate various digital sources to the identification functions described above to permit identification of an actor or entity associated with the activity. Shown in interface 600 is a voice message interface that includes identification displays for respective voice messages. For example, the voice message at 602 from “Anne” has been captured as an audio sample by the activity monitors. The audio sample can be used as an input to the identification operations described above.

In one embodiment, helper networks process the audio sample to ensure that the sample is good for processing (e.g., one voice is present, clear recording, limited noise or static, etc.). The validated audio sample can then be processed by embedding neural networks which are configured to transform the audio into encrypted feature vectors. Audio sample can also be pre-processed to sample segments of voice, transform pulse code modulated audio signal from the time domain to a representation in the frequency domain, among options, prior to input to the embedding networks. The encrypted feature vectors are then processed by a classification network to identify any match to a label. In this example, the classification network has been trained on voice embeddings from a number of contacts in the user's phone (e.g., Anne, Ed, Marcie, Mark, and Scott). Further the classification network has also been trained to identify other voice embeddings based on prior voice message (e.g., Unknown, 1 (949) 933 . . . “Melody”), P #1(617)646-8700)).

In some embodiments, identification labels can be derived from the digital activity being analyzed. In the “Melody” example, transcription of voice mail identifies a likely name—“Hi, this is Melody . . . ”. The system can associate such information with a classification label and/or use such information as a label as part of the identification operations. As shown in interface 600, identified actors can be shown with a checkmark or other positive indicator in the display. In other example, voice data that returns an unknown result locally can be shown by an hourglass, where a remote identification has been requested. (e.g., 604A and 604B). In further example, at 606 shown is an unknown actor who can be identified. In this example, prior voice messages enable the system to match the underlying identity of the actor leaving the voice message—even where the actual identity of the voice remains unknown.

Various embodiments can implement different treatment of such identified but unknown actors. For example, the UI can show that they are validated. In other examples, the system can request the current device user on an action to take with subsequent identification—(e.g., validate, block, mark spam, identify as marketer, etc.). Any designation made by the user can then be associated with the actor identifier and used for any subsequent activity. Further, subsequent activity can provide additional information. For example, subsequent activity may provide a transcription where the actor provides identifying information “This in Jane calling about your vehicle warranty . . . ”. The identity can now be linked with “Jane,” marketing, vehicle warranty, and likely spam for all subsequent activity, and even across a multitude of devices linked to a remote identification server.

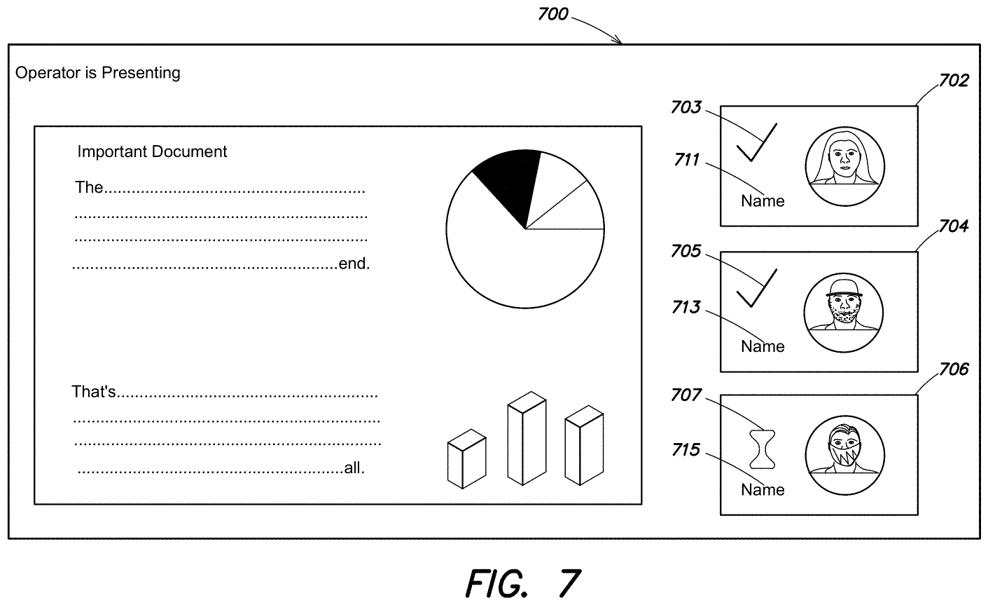

FIG. 7 is a screen capture of an example user interface 700 showing a video conference. As discussed above, activity monitors can be configured to identify video conferences as a source of identifying information. The activity monitors can be configured to identify areas of interest with such video conferences. In the example shown, participant windows are displayed at 702, 704, and 706. The activity monitors can identify the participant windows and capture identifying information (e.g., video, still image, audio, etc.) from those sources. In some embodiments, helper networks may be configured to identify areas of a user interface for capturing identification information, and facilitate capture of identification information from any user interface display in conjunction with, in addition to, and/or separately from any activity monitors.

Once the identifying information is selected, the information can be processed for identification as described above. For example, a helper network can validate information captured from 702 is a good data sample. Where the information is being captured live from an active video call, spoof detection helper networks can be used to determine that the identifying information is from a live user. Once the information is validated, embedding networks are configured to generated encrypted feature vectors for processing by classification networks. If matched, the display can reflect a validation check in proximity to the displayed actor (e.g., 703, 705). If there is no match to a known identification, the system can link a new identifier to the encrypted feature vectors and train the classification network for subsequent matching. In some embodiments, this occurs on a remote server and the updated classification network is communicated to a local device.

In some embodiments, a local device is configured to attempt a match, and if the return is an unknown result, a remote identification check can be made. For example, shown at 707 is an hourglass reflecting a remote check in progress. An “X” may be displayed if there is no remote match. The device user can then be prompted to add the actor into the identification classes for subsequent matching, provided additional information to associated with the actor, etc. For example, identification can be matched to profile information indicating a user name (e.g., at 711, 713, or 715). In other examples, a circle with a line through it may be displayed if the information obtained is not consistent with a match (e.g., name entered in video chat does not match identity or identity profile), or if the identity is a known security risk, among other options.

According to some embodiments, the activity monitors can be configured to transcribe the video conference or trigger a transcription service and compare or augment identity profiles based on transcriptions. For example, the activity monitors can be configured to identify each speaker in a transcription of the video conference. Data captured from the transcriptions can be associated with the identified speakers. In further embodiments, the activity monitors can continuously process identification information captured from the user interface, so if a new user joins the call, their identity will be determined. Furthermore, if a new person is introduced into any of the windows 702-706, the activity monitors are configured to identify them. In some settings, the system can display new identification information, even where two or more people are participating from any one window. In still other examples, continuous identification operations can be executed in the video conference.

According to some embodiments, video conferences can be secured by identification based functions. In one example, video may be blurred and/or audio muted until a validation of identity occurs. For unknown users, in various embodiments, the current device user would be able to enable functionality, and/or trigger the addition of the unknown actor to respective classification networks for subsequent identification.

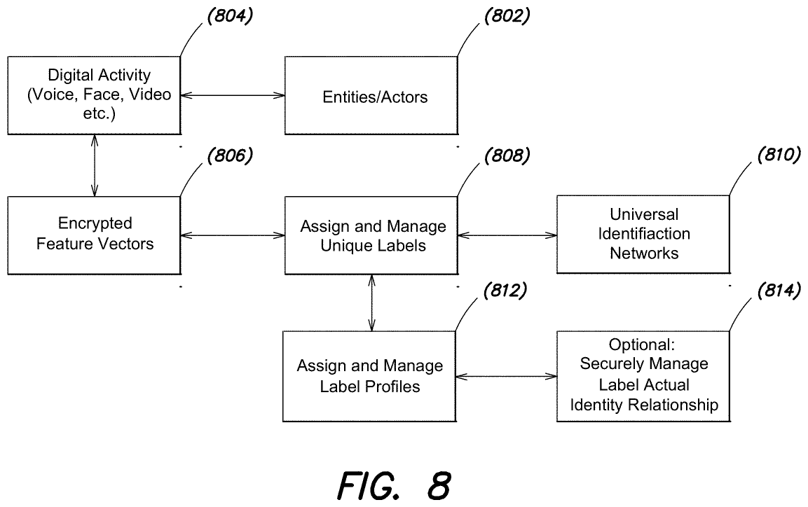

FIG. 8 illustrates a conceptual flow for universal identification. As shown entities (e.g., systems, processes, etc.) or actors (e.g., individual, groups, people, intelligences, etc.) (802) are responsible for digital activity/content (804) on devices. Where the digital activity includes identifying information (e.g., voice, audio, face images, biometric data, video, etc.) that activity can be processing by embedding networks to produce encrypted feature vectors (806) representing that activity. The system can assign and manage unique labels for respective encrypted feature vectors (808) which allows for training of universal identification networks (e.g., (810) including, for example, classification networks) that output the unique label whenever the respective encrypted feature vectors are input.

According to some aspects, identification can be separated from underlying identity and all that is required is a digital activity sample that can be processed into encrypted feature vectors to enable identification across any number of devices and any volume of activity. Various embodiments are configured for source identification associated with digital activity at internet scale. In conjunction with the unique labels, profile information can be captured or assigned based on observed digital activity (812). The profiles can be used to build activity history and/or associate information to a universally identifiable label, thus allowing tracing and/or tracking across any digital activity. Optionally, the label profiles can even be associated with an underlying actual identity (814). Various embodiments are configured to prevent or prohibit the linking of actual underlying identity as a security measure.

Broadly stated, universal identification networks permit a vast array of functions. According to one aspect, universal identification enables customer profile disambiguation on a level unachievable by conventional systems. Further, customer profiles can be disambiguated while not knowing the underling identity of the customer. In another aspect, computing devices can continuously validate a user identity based on any one or more of image capture, audio capture, video capture, and/or sensor capture. In further aspects, continuous identification enables seamless changes between users and any operational or functional assignments for those users. While conventional continuous authentication focuses on verifying the authorization of a specific user over time, continuous identification described herein allows devices to seamlessly transition between users and their associated function or operation settings on any device.

### Continuous Identification and Universal Device Environment Examples

According to some embodiments, trained classification networks enable the identification system to privately, continuously, securely, and unobtrusively switch between different personalized user profiles on any edge device. As discussed, conventional systems typically view continuous authentication as a verification function. In conventional settings, the user matches (true) or does not match (false). Thus an individual user is authorized and authorization is revoked upon failing the continuous authentication check. In various embodiments described herein, the concept and functionality for identifying user #2 on the device previously used by user 1, and switching to the profile for user #2 is not discussed, imagined, or enabled.

It is realized that conventionally device profiles are typically associated with devices and are not associated with users. Indeed, the device, device identity, and even on-device biometrics (where implemented) are only used as a proxy for the user. Instead of the conventional implementation, various embodiments of identification system implement a universal user identifier (UUID) that is associated with encrypted feature vectors. This UUID can be output by a classification network or geometric (e.g., distance, Euclidean, cosine, etc.) matching algorithm upon input of encrypted feature vectors associated with an actor or entity to uniquely identify users/entities. This UUID output can be used to access a profile and change a configuration of a vehicle, device, building, and/or system associated with the real-time profile. The configurations can include security and interface settings for any computer device or devices, and those settings can be adjusted based on the profile information.

To provide an example, a first user can access a Windows PC, where the device identifies and authenticates a first user (e.g., camera captures face image), and activates the first user profile on the device. The device then does not identify or authenticate the first user because the camera cannot visualize the first user (the trigger), and the screen is locked (goes blank). The device then identifies and authenticates the second user (the trigger). The device then switches to the second user profile and customizes operation of the Windows PC based on second user profile. To extend the example, into multiple user settings and multiple profile resolution—while the second user is present and being identified a third user then looks over the second user's shoulder (e.g., “shoulder surfing”). If the third user is unauthorized (does not have a role) to view the currently visualized material, the window(s) containing the material goes blank and/or is obscured (e.g., blurred, greyed-out, etc.).

In various embodiments, this functionality can be tuned to the specific content displayed on a given device. For example, a secured document is being displayed for which only the second user is authorized. When the third user shoulder surfs, the word processing application display is greyed out, but the rest of the display can be unaffected. In one example, this can include an internet browser display that is still active, a music service and currently playing song that remains active, among other examples. To provide another security example, specific sites shown through the browser can have security settings tied to a specific user. While the second user accesses and is browsing their bank information, the third user is identified on the camera triggering the display of the banking site to be obscured. In another embodiment, the failure to recognize an authorized user can occur when the second user is viewing their banking information, and in response the display is obscured because the new user is not identified and linked to authorization to view. The corollary to this example, the third user is identified and authorized, and the display of the banking information remains unaffected, where both the second and third users are authorized to view.

Further embodiments extend identification/authentication to other devices, including for example, a car sharing service. In one example, a first user approaches the car associated with the sharing service. Responsive to identification (e.g., biometric input, camera image capture, proximity signaling, etc.) the car opens and the driver seat is automatically adjusted based on the identified user's preference. The car and associated computing device track the usage of the vehicle and the first user's account is billed. Once the first user departs the car, the first user is logged out, and the cars settings can be returned to a default. In further example, a second user enters the sharing car, and upon identification of the second user, the car opens and the driver seat is automatically adjusted according to the second user's profile—retrieved based on identification of the second user. The car and associated computing device track the usage of the vehicle and the second user's account is billed. In some embodiments, the identification can even update user status during an active ride—the first user accesses the car, is identified (e.g., via face, voice, audio, etc. information), and the car adjusts according to the first user profile. Usage is tracked to bill to the first user. During the ride the first user stops and switches the driver with the second user. Here, the identification system identifies the second user in the driver's seat via capturing and processing identifying information (e.g., face, voice, etc.). The second user's profile can be accessed to adjust the seat to the second user's specifications. The first or second user can be prompted based on the state of identifying the second user to provide input on whether the second user will share in the charges for the shared vehicle—if the first or second user confirms the shared billing, each user can be tracked and billing allocated accordingly.

In various embodiments, the identification functions described herein can be implemented on a variety of edge devices (e.g., ATM, phone, game system, smart speaker, embedded or mobile device, vehicle, desktop PC, virtualized desktop PC (Amazon Workspace), laptop, email client (Slack), computer applications (Word, Google Docs), browser profiles, building management systems, building access systems, smart house devices, smart door locks, and/or other computer systems). Various embodiments link universal identities to unobtrusive, context-aware, and personalized environments that include supporting hoteling. Further embodiments are configured to support hoteling on the various device. For example one PC can be configured to host multiple people. In an operating scenario, one person gets up (device goes black), person 2 sits down (device shows their UI), person 3 looks over person 2's shoulder (device goes black if person 3 is not authorized to view the document, spreadsheet, email being displayed—or the portion of screen showing unauthorized content is obscured).

### Dynamic Multi-User Computer Configuration Settings Examples

Various embodiments provide a method and apparatus for improving the utilization of a resource in a shared client computer environment. According to one aspect, various embodiments overcome the problem inherent in using traditional computer programs on a shared client, by monitoring the status of an application, determining when an application does not need a resource, and causing the application to stop consuming the resource. In one embodiment, resource consumption is not halted, but the application is caused to use less of the resource. For example, the system can detect when a user has stopped interaction with an application. This can occur, for instance, when the user removes an identifier from the end user terminal. When the user interaction stops, the system is configured to execute a mechanism to stop a program from consuming resources (or to reduce its resource usage) and to restart it (or return it to its original state) later. The system can further include a procedure for stopping or reducing the resource usage of the application when the user has stopped interacting with it, and to restart it when the user begins (or is capable of beginning) interaction with it. All this is done without modifying the application that is executing in any way. Rather various embodiments are configured to implement identification functions to identify a user and computational usage, and upon change or loss of the identification of that user, limit or suspend computational usages of the resources associated with the previously identified user. Similarly, if a second user access the same device, their profile can be used to control the computational resources that are accessed, spun up, and/or subsequently limited or suspended.

### Identification for Distributing Digital Works

Further aspects of the identity functions described can include method for automatically distributing a user's digital-works and usage-rights to whatever computing system being used by one or more users. For example, when a user who is authorized to utilize a particular digital-work is active at a user-device (and identified), a version of said digital-work and authorization to utilize is automatically transferred to the device (e.g., this can be limited to when the work is needed at the user-device). In further examples, the digital-work and authorization may be automatically transferred between multiple devices as needed where an authorized user is active (e.g., identified and then determined authorized). In further embodiments, the system can use identification to manage usage-rights that may only be valid for one or more specific users, among other options. According to one embodiment, digital-works are automatically provided as needed to any user-device that an authorized user is using.

### Efficiency Examples (e.g., Using UUID for Customer Profile Disambiguation)

According to various embodiments, the system enables user identification based on typical interaction with a device. According to various embodiments, various neural networks manage identification based on captured audio samples of a user's voice. The system can be configured to extend identification functionality to enable disambiguation of end-users based on their private and secure identities. For example, within a contact center's interactive voice response (IVR) system, live calls and stored recorded calls, the system is configured to analyze available voice information to execute user disambiguation.

In conventional settings and using conventional tracking methodologies there exist many problems. For example, conventional tracking typically results in multiple customer profiles, where each “customer” is identified based on the phone number being used. This often results in multiple profiles for the same user/customer. In one example, such an approach can end up with tens or more profiles per customer. Many conventional approaches exist that attempt to clean up the multiple profiles, however these conventional approaches only reduce the problem and do not solve it.

In various embodiments, the identification system not only solves this problem going forward completely based on unique identification (even where the underlying user is unknown), but various embodiments of the system also enable disambiguation of old data and old profiles using the unique identification identities. For example, businesses have many call recordings (past phone calls) that generated old profiles. Assume that each profile has 1 or more linked (“associated”) call recordings. The system can process the old call recording to establish a unique identity for each. Importantly, the identification functions described herein are configured to detect an identity that is matches across multiple calls and matches regardless of other identifying information (e.g., different phone numbers, different iterations of name information, use of nicknames, etc.). The system is configured to generate encrypted feature vectors for each call recording, and then label the encrypted features vectors with a UUID, which can be used to establish or link to a user profile. Here because the system matches each underlying identity, all the duplicate profiles are matched with the same UUID, and can then be merged.

Going forward, any new incoming calls result in the system matching a voice sample to a UUID and links any activity (e.g., including the call) to the correct corresponding profile without duplicates. In the event of an unknown result, the system is configured to evaluate the unknown match to determine if the call generated an unknown result due to a bas sample, or is a new user and a new profile should be generated. In some examples, helper networks can filter out bad data so the bad information sample is not processed. In other examples, the system can save “unknown” results for further matching (e.g., on common phone number, name, connection information, etc.). In still other examples, the system can segregate unknown results and limit profile creation, collection, and/or merging to ones that are based on good data samples.

According to some embodiments, the identification system enables functionality based on an entity or actor identification. This enables a host of functions that are not conventionally available. For example, in the context of phone calls and functionality, there are known approaches for blocking callers based on the phone number or contact information that they are using. In a conventional approach, a list of phone numbers to deny can be used to filter unwanted calls. However, as is known such callers typically change their call from number or identity and alternatively spoof phone numbers to circumvent such approaches. It is realized by the inventors that private identity based deny lists (and similar functionality (e.g., allow lists, linked function to private identity, etc.)) are not subject to same constraints. For example, where identity is based on speaker recognition to generate a uuid, denial of an operation cannot be circumvented by switching a source phone number or other identifying information. Because the underlying actor can be linked to a uuid (even without the underlying actor's identity) the system's functionality cannot be circumvented, and operations can be blocked, allow, and selectively and/or conditionally triggered based on matching a uuid.

As described herein, privacy enabled, one-to-many identification of a callers' voice finds the associated UUID for the voice or actor of the underlying message. When a customer communicates with a particular entity, such as a contact center, the system can be configured to make a recording of the real-time call (e.g., using Amazon Kinesis Video Streams “KVS” or other capture and/or streaming service) including both the customer's and agent's voices. In some embodiments, the system is configured to segment the recording to extract at least a portion of the customer's voice to create an encrypted voice embedding, and can then transmit the encrypted voice embedding (encrypted payload) across the network to a server (e.g., for remote identification). The server is configured to determine any match and returns a matching label (e.g., uuid). The identification of the uuid can be used for a variety of purposes, such as determining whether to block (deny) the caller or authorize an operation (e.g., a transaction) requested by the customer. In various other embodiment, the ability to uniquely identify an underlying actor enable identity based functions across a variety of environments and function sets. The functions can include capturing and identifying a user in a video conference based on encrypted feature vector and uuid. The current user can identify specific functions to associate with the identity, and thus voice captured in video conference can enable identification functions (e.g., block, allow, tailor presentation, identify importance, trigger transcription, trigger full recording, trigger separate application, trigger new conference call with new participants, etc.) in other settings (e.g., subsequent voice call, twitch stream, video game chat session, etc.).

Example Identity Architecture

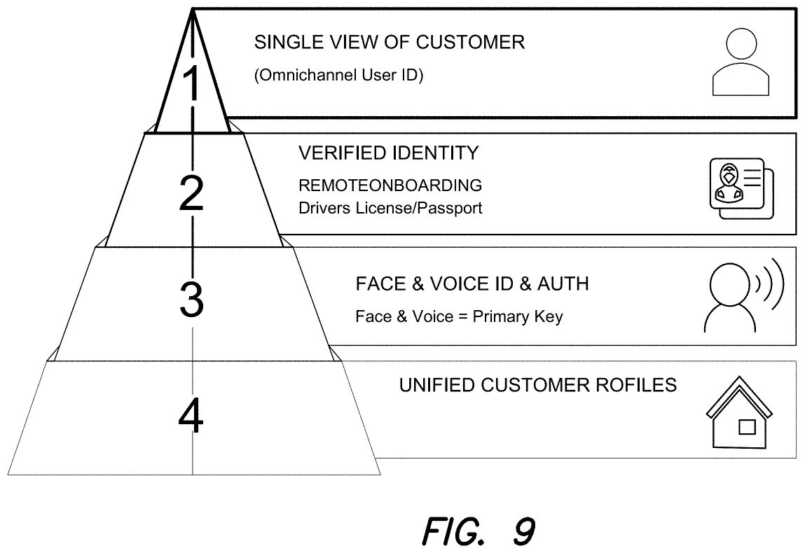

FIG. 9 is a conceptual diagram for implementing unique identification where a single view of a customer identity can be implemented and used to enable various functionality and/or to define and manage unified customer profiles. As discussed above, the functionality can include operations to display identity information as part of other applications and/or services. In some environments, a unique and verified identity can be constructed from a user's biometric and/or behavioral identification information. The verification can include a remote onboarding process to verify the user with a driver's license and/or passport as well to verify the same once onboard. Separate face and voice identities (among other examples) can be used by the system to validate and/or identify a user in various context, and may be used together, for example, to ensure correct identification. As show, the identification (e.g., face, voice, etc.) can then be used in managing unified customer profiles. In one example, the unified customer profiles can be used to associate activity information unambiguously and with concerns of changing connection information, contact information, and even with incorrectly furnished information.

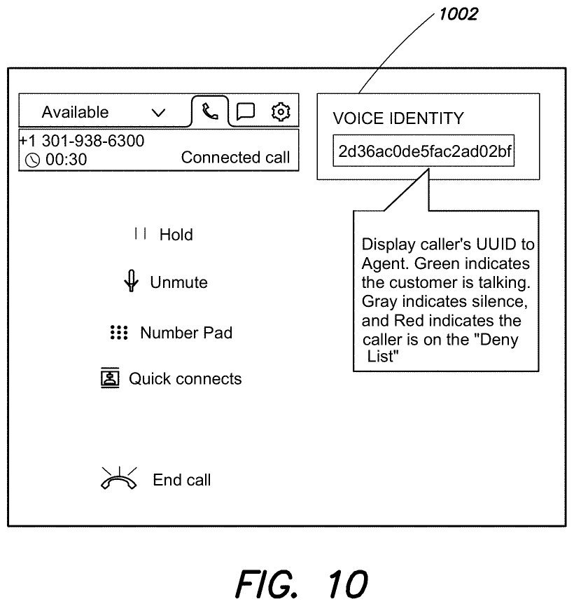

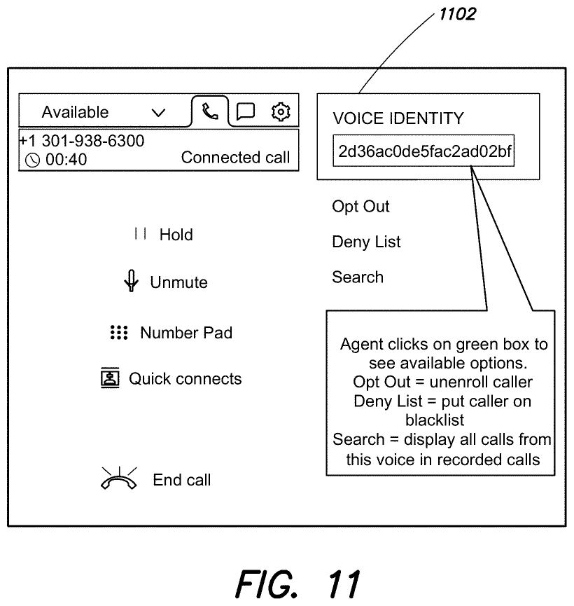

FIG. 10 is an example user interface for using and displaying voice identity information. The interface illustrates addition functionality integrated into an ongoing call display. For example, at 1002, shown is a uuid associated with the voice information being communicated in the call. The display can include additional functions to convey information on the current context and identity information being provided. FIG. 11 is another user interface that makes addition operations available to a user based on the identification information, and functions that can be tied to a particular identity. For example, at 1102, a voice identity can be added to a deny list, and irrespective of context (e.g., new phone number, embedded in voice conference, video call, etc.), the voice identity will be recognized by the system and the selected action will be executed. For a “Deny List,” the voice identity will be blocked and/or dropped from ongoing communication. Opt out provides a function to unenroll a voice identity/caller, and search provides a function to search or list matching content that includes the selected voice identity.

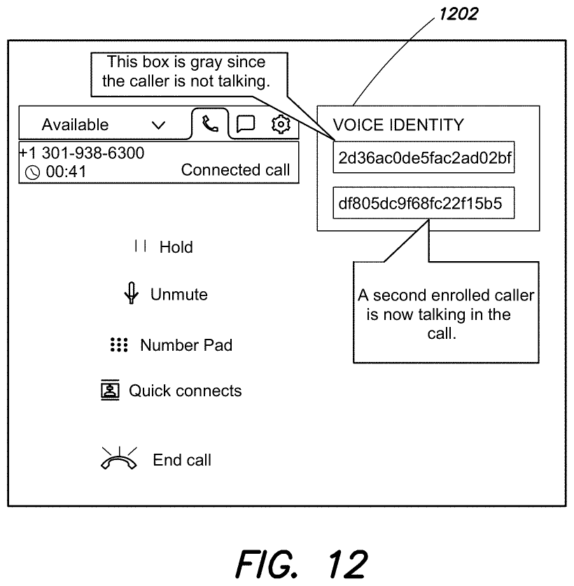

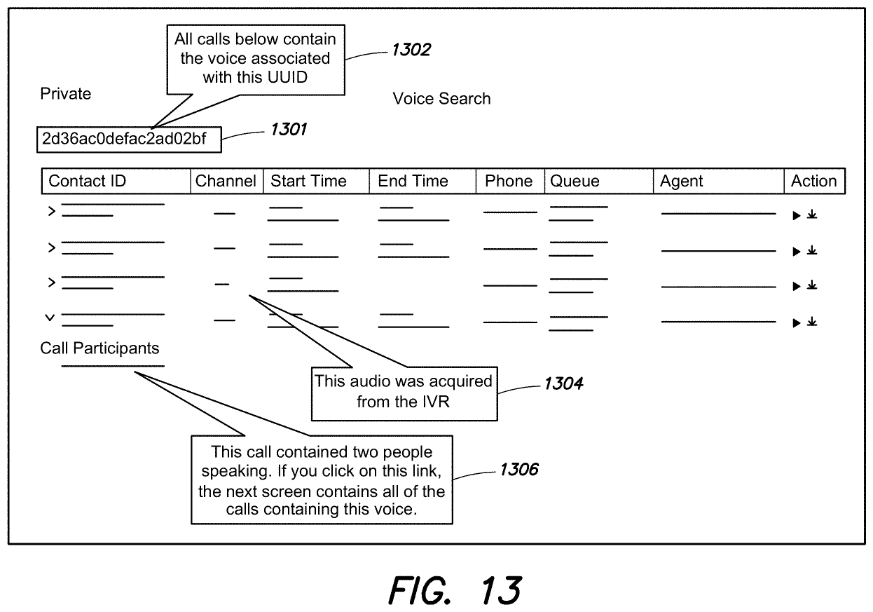

FIG. 12 is an example user interface showing a multi-caller call and associated displays of voice identities of the participants at 1202. FIG. 13 is an example user interface showing a voice identity search display (which can be triggered for example at drop down menu shown at 1102 of FIG. 11). At 1301, the searched voice identity can be displayed. In some examples, the displayed identity can be used to show all content matching or containing the voice identity (e.g., described at 1302). The display can be separated into content that matches the identity (e.g., at lines 1-4 of the contact ID display) and content that contains the identity (e.g., shown at 1306). For each call shown, the source of the call or communication channel information can be shown (e.g., at 1304).

### Generation and Classification of Encrypted Feature Vectors

According to some embodiments, the system is configured to provide one to many search and/or matching on encrypted biometrics in polynomial time. According to one embodiment, the system takes input biometrics and transforms the input biometrics into feature vectors (e.g., a list of floating point numbers (e.g., 128, 256, or within a range of at least 64 and 10240, although some embodiments can use more feature vectors)). According to various embodiments, the number of floating point numbers in each list depends on the machine learning model being employed. For example, the known FACENET model by GOOGLE generates a feature vector list of 128 floating point numbers, but other embodiments use models with different feature vectors and, for example, lists of floating point numbers.

According to various embodiments, the biometrics processing model (e.g., deep learning convolution network (e.g., for images and/or faces)) is configured such that each feature vector is Euclidean measurable when output. The input (e.g., the biometric) to the model can be encrypted using a neural network to output a homomorphic encrypted value. According to one aspect, by executing on feature vectors that are Euclidean measurable—the system produces and operates on one way homomorphic encryptions of input biometrics. These one way homomorphic encryptions can be used in encrypted operations (e.g., addition, multiplication, comparison, etc.) without knowing the underlying plaintext value. Thus, the original or input biometric can simply be discarded, and does not represent a point of failure for security thereafter. In further aspects, implementing one way encryptions eliminates the need for encryption keys that can likewise be compromised. This is a failing of many convention systems.

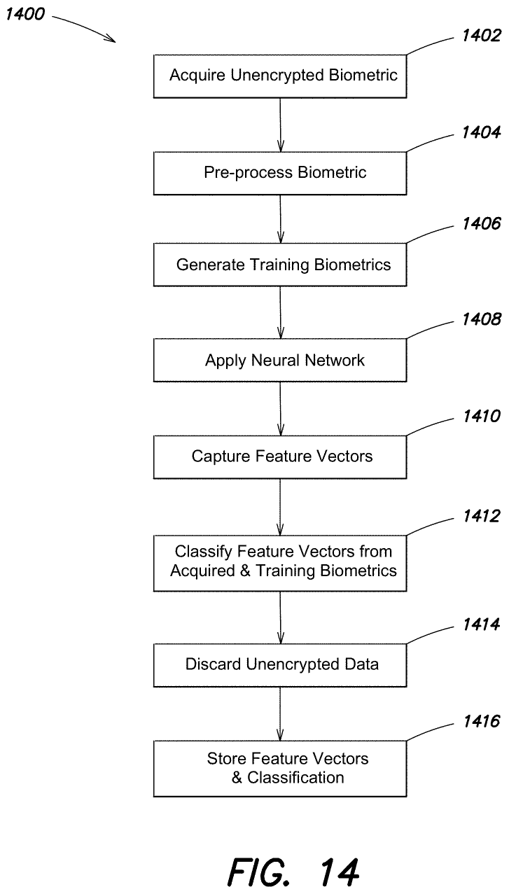

FIG. 14 is an example process flow 1400 for enrolling in a privacy-enabled identification system. Process 1400 begins with acquisition of unencrypted identification information (e.g., biometric data) at 1402. The unencrypted biometric data (e.g., plaintext, reference biometric, etc.) can be directly captured on a user device, received from an acquisition device, or communicated from stored biometric information. In one example, a user takes a photo of themselves on their mobile device for enrollment. Pre-processing steps can be executed on the biometric information at 1404. For example, given a photo of a user, pre-processing can include cropping the image to significant portions (e.g., around the face or facial features). Various examples exist of photo processing options that can take a reference image and identify facial areas automatically.

In another example, the end user can be provided a user interface that displays a reference area, and the user is instructed to position their face from an existing image into the designated area. Alternatively, when the user takes a photo, the identified area can direct the user to focus on their face so that it appears within the highlight area. In other options, the system can analyze other types of images to identify areas of interest (e.g., iris scans, hand images, fingerprint, etc.) and crop images accordingly. In yet other options, samples of voice recordings can be used to select data of the highest quality (e.g., lowest background noise), or can be processed to eliminate interference from the acquired biometric (e.g., filter out background noise).

Having a given biometric, the process 1400 continues with generation of additional training biometrics at 1406. For example, a number of additional images can be generated from an acquired facial image. In one example, an additional twenty five images are created to form a training set of images. In some examples, as few as three images can be used but with the tradeoff of reduce accuracy. In other examples, as many as forty training images may be created. The training set is used to provide for variation of the initial biometric information, and the specific number of additional training points can be tailored to a desired accuracy. Various ranges of training set production can be used in different embodiments (e.g., any set of images from one to one thousand). For an image set, the training group can include images of different lighting, capture angle, positioning, etc. For audio based biometrics different background noises can be introduced, different words can be used, different samples from the same vocal biometric can be used in the training set, among other options. Various embodiments of the system are configured to handle multiple different biometric inputs including even health profiles that are based at least in part on health readings from health sensors (e.g., heart rate, blood pressure, EEG signals, body mass scans, genome, etc.). According to various embodiments, biometric information includes Initial Biometric Values (IBV) a set of plaintext values (pictures, voice, SSNO, driver's license number, etc.) or any other Personally Identifiable Information (“PII”) that together define a person. In some examples, the biometric value itself may be stored as PII and this plaintext may become searchable and privacy enhanced by using homomorphic encryption generating Euclidean Measurable ciphertext.

At 1408, feature vectors are generated from the initial biometric information (e.g., one or more plain text values that identify an individual). Feature vectors are generated based on all available biometric information which can include a set of and training biometrics generated from the initial unencrypted biometric information received on an individual or individuals. According to one embodiment, the IBV is used in enrollment and for example in process 1400. The set of IBVs are processed into a set of initial biometric vectors (e.g., feature vectors) which are used downstream in a subsequent neural network.

In one implementation, users are directed to a website to input one or multiple data points for biometric information (e.g., multiple pictures including facial images) in conjunction with personally identifiable information (“PII”). The system and/or execution of process 1400 can include tying the PII to encryptions of the biometric as discussed below.

In one embodiment, a convolutional deep neural network is executed to process the unencrypted biometric information and transform it into feature vector which has a property of being one-way encrypted cipher text. The neural network is applied (1408) to compute a one-way homomorphic encryption of the biometric—resulting in feature vectors (e.g., at 1410). These outputs can be computed from an original biometric using the neural network but the values are one way in that the neural network cannot then be used to regenerate the original biometrics from the outputs.

Various embodiments take as input a neural network capable of taking plaintext input and returning Euclidean measurable output. One such implementation is FaceNet which takes in any image of a face and returns 1428 floating point numbers, as the feature vector. The neural network is fairly open ended, where various implementations are configured to return a Euclidean measurable feature vector that maps to the input. This feature vector is nearly impossible to use recreate the original input biometric and is therefore considered a one-way encryption.

Various embodiments are configured to accept the feature vector(s) produced by a first neural network and use it as input to a new neural network (e.g., a second classifying neural network). According to one example, the new neural network has additional properties. This neural network is specially configured to enable incremental training (e.g., on new users and/or new feature vectors) and configured to distinguish between a known person and an unknown person. In one example, a fully connected neural network with 2 hidden layers and a “hinge” loss function is used to process input feature vectors and return a known person identifier (e.g., person label or class) or indicate that the processed biometric feature vectors are not mapped to a known person. For example, the hinge loss function outputs one or more negative values if the feature vector is unknown. In other examples, the output of the second neural network is an array of values, wherein the values and their positions in the array determined a match to a person.

Various embodiments use different machine learning models for capturing feature vectors in the first network. According to various embodiments, the feature vector capture is accomplished via a pre-trained neural network (including, for example, a convolutional neural network) where the output is Euclidean measurable. In some examples, this can include models having a softmax layer as part of the model, and capture of feature vectors can occur preceding such layers. Feature vectors can be extracted from the pre-trained neural network by capturing results from the layers that are Euclidean measurable. In some examples, the softmax layer or categorical distribution layer is the final layer of the model, and feature vectors can be extracted from the n−1 layer (e.g., the immediately preceding layer). In other examples, the feature vectors can be extracted from the model in layers preceding the last layer. Some implementations may offer the feature vector as the last layer.

The resulting feature vectors are bound to a specific user classification at 1412. For example, deep learning is executed at 1412 on the feature vectors based on a fully connected neural network (e.g., a second neural network). The execution is run against all the biometric data (i.e., feature vectors from the initial biometric and training biometric data) to create the classification information. According to one example, a fully connected neural network having two hidden layers is employed for classification of the biometric data. In another example, a fully connected network with no hidden layers can be used for the classification. According to one embodiment, process 1400 can be executed to receive an original biometric (e.g., at 1402) generate feature vectors (e.g., 1410), and apply a FCNN classifier to generate a label to identify a person at 1412 (e.g., output #people).

Process 1400 continues with discarding any unencrypted biometric data at 1414. In one example, an application on the user's phone is configured to enable enrollment of captured biometric information and configured to delete the original biometric information once processed (e.g., at 1414). In other embodiments, a server system can process received biometric information and delete the original biometric information once processed. According to some aspects, only requiring that original biometric information exists for a short period during processing or enrollment significantly improves the security of the system over conventional approaches. For example, systems that persistently store or employ original biometric data become a source of vulnerability. Unlike a password that can be reset, a compromised biometric remains compromised, virtually forever.

Returning to process 1400, at 1416 the resulting cipher text (e.g., feature vectors) biometric is stored. In one example, the encrypted biometric can be stored locally on a user device. In other examples, the generated encrypted biometric can be stored on a server, in the cloud, a dedicated data store, or any combination thereof. In one example, the biometrics and classification are stored for use in subsequent matching or searching. For instance, new biometric information can be processed to determine if the new biometric information matches any classifications. The match (depending on a probability threshold) can then be used for authentication or validation.

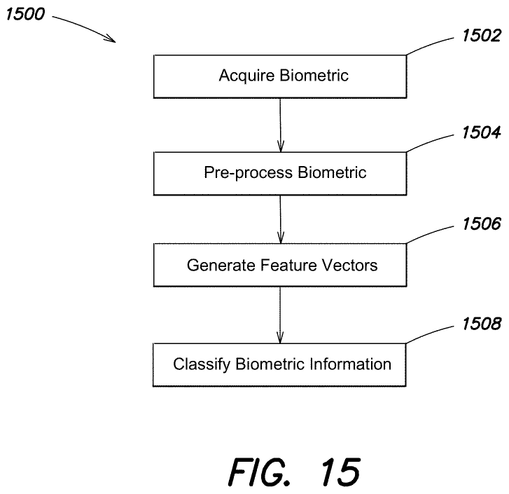

FIG. 15 illustrates an example process 1500 for authentication with secured biometric data. Process 1500 begins with acquisition of multiple unencrypted biometrics for analysis at 1502. In one example, the privacy-enabled biometric system is configured to require at least three biometric identifiers (e.g., as plaintext data, reference biometric, or similar identifiers). If for example, an authentication session is initiated, the process can be executed so that it only continues to the subsequent steps if a sufficient number of biometric samples are taken, given, and/or acquired. The number of required biometric samples can vary, and take place with as few as one.

Similar to process 1400, the acquired biometrics can be pre-processed at 1504 (e.g., images cropped to facial features, voice sampled, iris scans cropped to relevant portions, etc.). Once pre-processing is executed the biometric information is transformed into a one-way homomorphic encryption of the biometric information to acquire the feature vectors for the biometrics under analysis (e.g., at 1506). Similar to process 1400, the feature vectors can be acquired using any pre-trained neural network that outputs Euclidean measurable feature vectors. In one example, this includes a pre-trained neural network that incorporates a softmax layer. However, other examples do not require the pre-trained neural network to include a softmax layer, only that they output Euclidean measurable feature vectors. In one, example, the feature vectors can be obtained in the layer preceding the softmax layer as part of step 1506.

At 1508, a prediction (e.g., a via deep learning neural network) is executed to determine if there is a match for the person associated with the analyzed biometrics. As discussed above with respect to process 1500, the prediction can be executed as a fully connected neural network having two hidden layers (during enrollment the neural network is configured to identify input feature vectors as individuals or unknown, and unknown individuals can be added via incremental training or full retraining of the model). In incremental training examples, a neural network is instantiated with more nodes than are required so an identity can be integrated into an existing node of the neural network without changing other aspects of the architecture. In other examples, a fully connected neural network having no hidden layers can be used.

According to one embodiment, the FCNN outputs an array of values. These values, based on their position and the value itself, determine the label or unknown. According to one embodiment, returned from a one to many case are a series of probabilities associated with the match—assuming five people in the trained data: the output layer showing probability of match by person: [0.1, 0.9, 0.3, 0.2, 0.1] yields a match on Person 2 based on a threshold set for the classifier (e.g., >0.5). In another run, the output layer: [0.1, 0.6, 0.3, 0.8, 0.1] yields a match on Person 2 & Person 4 (e.g., using the same threshold).

However, where two results exceed the match threshold, the process and or system is configured to select the maximum value and yield a (probabilistic) match Person 4. In another example, the output layer: [0.1, 0.2, 0.3, 0.2, 0.1] shows no match to a known person—hence an UNKNOWN person—as no values exceed the threshold. Interestingly, this may result in adding the person into the list of authorized people (e.g., via enrollment discussed above), or this may result in the person being denied access or privileges on an application. According to various embodiments, process 1500 is executed to determine if the person is known or not. The functions that result can be dictated by the application that requests identification of an analyzed biometrics.

According to another aspect, a private authentication system can invoke multiple authentication methodologies. For example, a distance metric store can be configured to store encrypted feature vectors so that newly created encrypted feature vectors can be compared to determine if they are within a threshold distance (match) or not. Other embodiments are configured to process stored encrypted featured vectors for geometric matching. Such geometric or distance checks can be used in an initial enrollment phase that permits quick identification. For example, the system can used store embeddings to evaluate newly generated embeddings based on geometric distance, cosine evaluation, Euclidean measurement, etc. When the distance is within a certain threshold, the user can be identified or authenticated.

In various embodiments, the distance store and direct comparison of stored feature vectors with newly generated ones is used as a rough or coarse identification or authentication approach that can be quickly executed for identification or authentication. In some embodiments. during the initial phase, a more sophisticated authentication approach can be trained—i.e. a DNN can be trained on encrypted feature vectors (e.g., Euclidean measurable feature vectors, distance measurable feature vectors, geometric measurable homomorphic encrypted feature vectors, etc., which can be derived from any one or more biometric measurement and/or from any one or more behavioral measurement also referred to as embeddings) and identification labels, so that upon input of an encrypted feature vector the DNN can return an identification label (or unknown result, where applicable).

According to further aspects, a privacy preserving authentication system can execute hybrid authentication schemes, a fast authentication approach (e.g., geometry/distance evaluations of encrypted authentication information (e.g., biometrics and/or behavioral information) coupled with a more robust trained DNN approach that takes longer to establish. Once ready, the system can use either authentication approach (e.g., switch over to the trained DNN approach (e.g., neural network accepts encrypted feature vector as input and returns an identification label or unknown result)). In yet further embodiments, the system is configured to leverage a fast authentication approach for new enrollments and/or updates to authentication information and use, for example, multiple threads for distance authentication and deep learning authentication (e.g., with the trained DNN) once the DNN trained on encrypted feature vectors is ready.

For an UNKNOWN person, i.e. a person never trained to the deep learning enrollment and prediction neural network, an output layer of an UNKNOWN person looks like [−0.7, −1.7, −6.0, −4.3]. In this case, the hinge loss function has guaranteed that the vector output is all negative. This is the case of an UNKNOWN person. In various embodiments, the deep learning neural network must have the capability to determine if a person is UNKNOWN. Other solutions that appear viable, for example, support vector machine (“SVM”) solutions break when considering the UNKNOWN case. According to various embodiments, the deep learning neural network (e.g., an enrollment & prediction neural network) is configured to train and predict in polynomial time.

Various implementations of the system have the capacity to use this approach for more than one set of input. The approach itself is biometric agnostic. Various embodiments employ feature vectors that are Euclidean measurable, which is handled using the first neural network—first in this example is used to describe a class of neural network that produces encrypted feature vectors from plaintext biometric input that are then used to train second networks a class of neural network that classifies the encrypted feature vectors. In some instances, different neural networks are configured to process different types of biometrics. Using that approach the vector generating neural network may be swapped for or use a different neural network in conjunction with others where each is capable of creating a Euclidean measurable, geometrically measurable, or distance measurable feature vector based on the respective biometric. Similarly, the system may enroll in many biometric types (e.g., use two or more vector generating networks) and predict on the features vectors generated for many types of biometrics using many neural networks for processing a respective biometric type simultaneously. In one embodiment, feature vectors from each type of biometric can likewise be processed in respective deep neural networks configured to predict matches based on feature vector inputs or return unknown. In various embodiments, threaded operation can be configured to produce simultaneous results (e.g., one from each biometric type) that may be used to identify using a voting scheme that may improve accuracy by firing multiple predictions simultaneously.

According to some embodiments, optional processing of the generated encrypted biometrics can include filter operations prior to passing the encrypted biometrics to classifier neural networks (e.g., a DNN). For example, the generated encrypted feature vectors can be evaluated for distance (e.g., Euclidean and/or geometric, etc.) to determine that they meet a validation threshold. In various embodiments, the validation threshold is used by the system to filter noisy or encrypted values that are too far apart. For example, noisy or bad data and the resulting embeddings would reduce the accuracy of networks trained on them.

According to one aspect, filtering of the encrypted feature vectors improves the subsequent training and prediction accuracy of the classification networks. In essence, if a set of encrypted embeddings for a user are too far apart (e.g., distances between the encrypted values are above the validation threshold) the system can reject the enrollment attempt, request new biometric measurements, generate additional training biometrics, etc.

Example Validation of Match

Additional embodiments can also incorporate validation of matches produced by classification networks. For example, matches can be validated based on geometric or distance measurements on encrypted authentication credentials produced (e.g., by a respective embedding network) against those stored in memory. Further example, unknown results can be validated to ensure the input is unknown based on geometric or distance evaluation. For example, likely matches and their stored embeddings can be checked to determine if the distance between newly produced embeddings is within a threshold distance of one of the most likely matches.

According to another aspect, the inventors have realized that conventional approaches in this space that seek to tune training sets and/or machine learning models to resolve accuracy issues, fail to address the large class problem of the generation/classification architecture. In a departure from conventional implementation, various embodiments introduce a post output validation protocol that yields vast improvement in accuracy over conventional approaches.

According to one embodiment, responsive to generating a prediction by a classification network, the system is configured to execute a validation of the results. In one embodiment, validation can be executed on the closest match or a plurality of closest matches identified by the classification network. For example, an encrypted authentication credential can be input into the classification network, and the classification network can output an array of probabilities that the input matches to trained labels in the network. According to some embodiments, where the elements of the array do not meet a threshold for valid identification, the system can be configured to execute subsequent validation. For example, the system can use the closest matches determined by the classification network (e.g., 1, 2, 3, 4, 5 or more) or the highest probability matches, retrieve the encrypted authentication credential associated with the closest matches and execute a geometric or distance based evaluation on the input encrypted authentication credential submitted to the classification network.

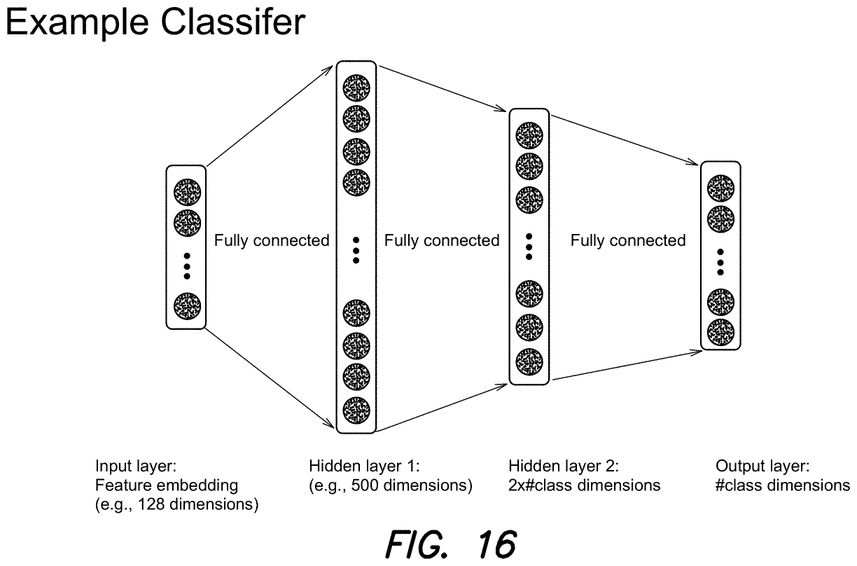

FIG. 16 illustrates an example embodiments of a classifier network. The embodiment shows a fully connected neural network for classifying feature vectors for training and for prediction. Other embodiments implement different neural networks, including for example, neural networks that are not fully connected. Examples of the classification network accept Euclidean or distance measurable feature vectors and return a label or unknown result for prediction or binds the feature vectors to a label during training.

Various operations are enabled by various embodiments, and the functions include, for example:
Encrypted Match: using the techniques described herein, a deep neural network (“DNN”) is used to process a reference biometric to compute a one-way, homomorphic encryption of the biometric's feature vector before transmitting or storing any data. This allows for computations and comparisons on cipher texts without decryption, and ensures that only the Euclidean measurable, homomorphic encrypted biometric is available to execute subsequent matches in the encrypted space. The plaintext data can then be discarded and the resultant homomorphic encryption is then transmitted and stored in a datastore. This example allows for computations and comparisons on ciphertexts without decryption and ensures that only the Euclidean measurable, homomorphic encrypted biometric is available to execute subsequent matches in the encrypted space.
Encrypted Search: using the techniques described herein, encrypted search is done in polynomial time according to various embodiments. This allows for comparisons of biometrics and achieves values for comparison that indicate “closeness” of two biometrics to one another in the encrypted space (e.g., a biometric to a reference biometric) while at the same time providing for the highest level of privacy.

According to one embodiment, the system can be described broadly to include the any one or more or any combination of the following elements and associated functions:
Preprocessing: where the system takes in an unprocessed biometric, which can include cropping and aligning and either continues processing or returns that the biometric cannot be processed.
Neural network 1: Pre-trained. Takes in plaintext identification information (e.g., unencrypted biometric information, behavioral, etc.). Returns encrypted feature vectors that are one way encrypted and distance or Euclidean measurable.
Neural network 2: Not pre-trained during enrollment, and pre-trained during prediction. It is a deep learning neural network that does classification. Includes incremental training, takes a set of label, feature vector pairs as input and returns nothing during training—the trained network is used for matching or prediction on newly input identifying (e.g., encrypted biometric) information. Does prediction, which takes a feature vector as input and returns an array of values. These values, based on their position and the value itself, determine the label or unknown.
Voting functions can be executed with neural network 2 e.g., during prediction.
System may have more than one neural network 1 for different identifying information (e.g., biometrics, behavioral, etc.). Each would generate feature vectors based on unencrypted input.
System may have multiple neural network 2(s) one for each identifying information type.

### Helper Network Embodiments

In further embodiments, helper networks can be implemented in an identification and/or authentication systems and operate as a gateway for embedding neural networks (e.g., networks that create encrypted feature vectors) that extract encrypted features from authentication information and/or as a gateway for prediction models that predict matches between input and enrolled authentication information. According to various aspects, embedding machine learning models can be tailored to respective authentication modalities, and similarly, helper networks can be configured to process specific authentication inputs or authentication modalities and validate the same before they are used in subsequent models. An authentication modality can be associated with the sensor/system used to capture the authentication information (e.g., image capture for face, iris, or fingerprint, audio capture for voice, etc.), and may be further limited based on the type of information being analyzed within a data capture (e.g., face, iris, fingerprint, voice, behavior, etc.). Broadly stated, authentication modality refers to the capability in the first instance to identify a subject to confirm an assertion of identity and/or to authenticate the subject to adjudicate identity and/or authorization based on a common set of identity information. In one example, an authentication modality can collect facial images to train a neural network on a common authentication data input. In another example, speech inputs or more generally audio inputs can be processed by a first embedding network, where physical biometric input (e.g., face, iris, etc.) can be processed by another first embedding network trained on the different authentication modality. In some embodiments, first is used to delineate network function—create encrypted feature vectors or embeddings, first network, and classify encrypted feature vectors, second network. In such examples, order of network designations is not relevant, rather the difference in function is being highlighted by the designation to facilitate understanding.

In further example, image captures for user faces can be processed as a different modality from image capture for iris identification, and/or fingerprint identification. Other authentication modalities can include behavioral identification information (e.g., speech pattern, movement patterns (e.g., angle of carrying mobile device, etc.), timing of activity, location of activity, etc.), passive identification information capture, active identification information capture, among other options.

Assuming, that both good and bad identification information samples are taken as part of information capture, the helper networks operate to filter out bad information prior to training, which prevents, for example, information that is valid but poorly captured from impacting training or prediction using various neural networks. Additionally, helper networks can also identify and prevent presentation attacks or submission of spoofed authentication.

According to some embodiments, validation and generation of identification information can be supported by execution of various helper networks. According to one embodiment, these specially configured helper networks can be architected based on the type of identification information/credential to be processed or more generally based on an authentication modality being processed.

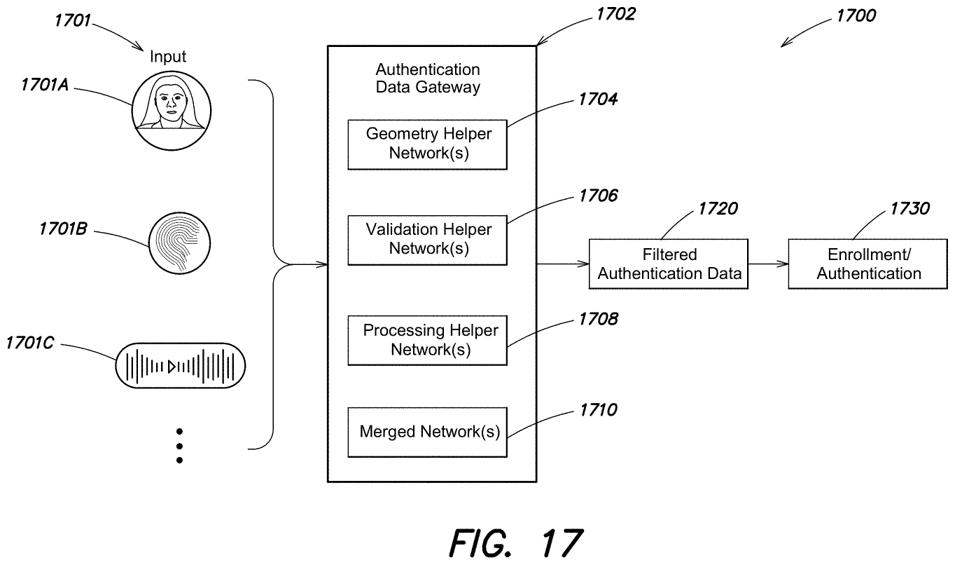

FIG. 17 is a block diagram of an identification system 1700. According to various embodiments the identification system 1700 can accept a variety of identification inputs (e.g., 1701) and produce filtered identification data (e.g., at 1720) for use in identification/enrollment/authentication functions (e.g., 1730). For example, the identification system 1700 can be configured to accept various biometric inputs 1701A including images of a user's face, 1701B including images of a user's fingerprint, 1701C including captures of the user's voice, among other options (e.g., as shown by the three dots appearing under the various inputs). According to some embodiments, the identification system can be configured with an authentication gateway 1702. The authentication gateway may include a plurality of helper networks each tailored to process a respective identification input. For example, a helper network can be tailored specifically to deal with facial recognition images and/or video for identifying a user face. Different types of helper networks can be tailored to specific functions, including, for example, geometry helper networks (e.g., 1704) that are configured to identify characteristics within an identification/authentication input and/or positional information within the input that can be used for validation and/or creation of embedding (e.g., encrypted feature vectors produced by an embedding network—discussed below).

In various embodiments, geometry helper networks can be configured to support analysis by validation helper networks (e.g., 1706). Although in other embodiments, validation helper networks are configured to operate on input data without requiring the output or analysis of geometry helper networks. In yet other embodiments, some validation networks can receive information from geometry helper networks while other helper networks operate independently and ultimately deliver an assessment of the validity of an identification/authentication instance. In the context of image inputs, the validation helper network can determine that the submitted image is too blurry, off-center, skewed, taken in poor lighting conditions, among other options, that lead to a determination of a bad instance.

In some embodiments, the various helper networks can include processing helper networks configured to manage inputs that are not readily adaptable to geometric analysis. In some examples, the processing helper networks (e.g., 1708) can also be loosely described as geometry helper networks and the two classifications are not mutually exclusive, and are describe herein to facilitate understanding and to illustrate potential applications without limitation. According to one example, processing helper networks can take input audio information and isolate singular voices within the audio sample. In one example, a processing helper network can be configured for voice input segmentation and configured to acquire voice samples of various time windows across an audio input (e.g., multiple samples of 10 ms may be captured from one second to input). The processing helper networks can take audio input and include pulse code modulation transformation (PCM) that down samples the audio time segments to a multiple of the frequency range (e.g., two times the frequency range). In further example, PCM can be coupled with fast fourier transforms to convert the audio signal from the time domain to a frequency domain.

In some embodiments, a series of helper networks can be merged into a singular neural network (e.g., 1710) that performs the operations of all the neural networks that have been merged. For example, geometry helper networks can be merged with validation helper networks and the merged network can be configured to provide an output associated with validity of the identification/authentication data input.

Regardless of whether a plurality of helper networks is used or a merged network is used or even combinations thereof, the authentication data gateway 1702 produces a set of filtered authentication data (e.g., 1720) that has pruned bad authentication instances from the data set. Shown in FIG. 17 is communication of the filtered authentication data 1720 for use in identification, enrollment, and/or authentication services at 1730. In some embodiments, an identification system can include components for performing identification of entities, enrollment of users, and components for authenticating enrolled users. Filtered data can be used for any preceding operation. In some examples, filtering of training data can be prioritized, and an identification system does not need to filter authentication inputs when performing a specific request for authentication against enrolled data. In some other embodiments, an identification system can provide data gateway operations and pass the filtered data onto other systems that may be used to identify, enroll, and/or authenticate users. Other implementations can provide data gateway operations, identification operations, enrollment operations and/or authentication operations as part of a single system or as part of a distributed system with multiple participants.

In other embodiments, the operation of the helper networks shown can be used in the context of identification. The helper networks are used to ensure valid data capture that can then be used in identifying an individual or entity based on acquired information. Broadly stated, the geometry and/or processing helper networks operate to find identification data in an input, which is communicated to respective validation helper networks to ensure a valid submission has been presented. One example of an identification setting versus an authentication setting, can include airport security and identification of passengers. According to various embodiments, identification is the goal in such example and authentication (e.g., additional functions for role gathering and adjudication) is not necessary once a passenger has been identified. Conversely, the system may be tasked with authenticating a pilot (e.g., identification of the pilot, determining role information for the pilot, and adjudication) when seeking to access a plane or plane flight control systems.

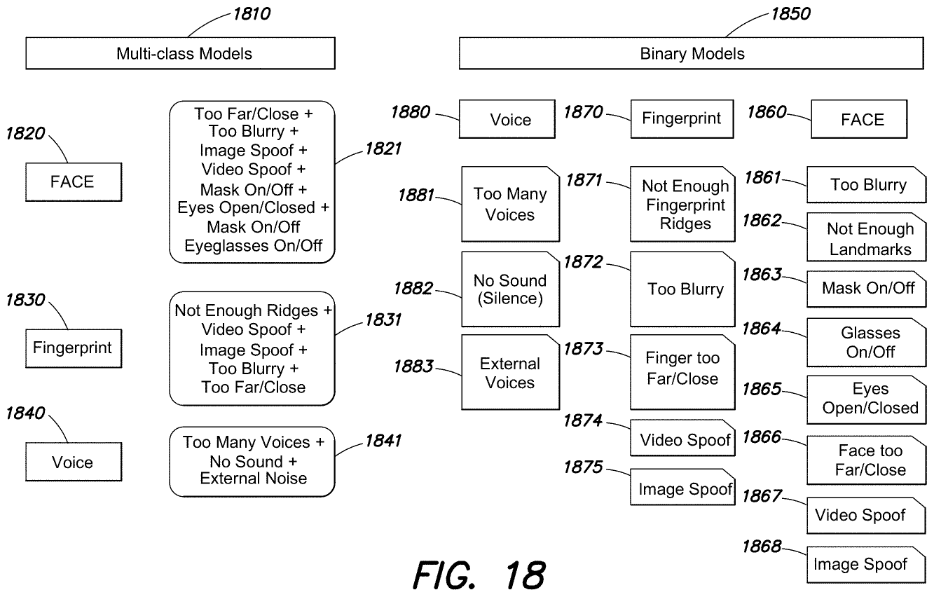

FIG. 18 is a block diagram illustrating various example helper networks, according to various embodiments. According to one embodiment, an authentication system can execute a variety of different helper networks architected on a variety of models. For example, a group of helper networks can be configured to establish one of a pair of states. Stated broadly, the helper networks configured to establish one of a pair of states responsive to input can be referred to as binary models. For example, a respective binary helper network is configured to determine if an input is associated with the first or second state. In an identification or authentication setting, a variety of helper networks can be configured to process images for facial recognition (e.g., 1860) using a plurality of binary or other models.

According to some embodiments, face processing helper networks can include evaluations of whether, or not, an image is too blurry to use in the context of identification, authentication, and/or training. In another example, a face helper network can be configured to determine if there are not enough landmarks in an input image for facial recognition or in the alternative if there are (e.g., 1862). Further embodiments include any combination of the prior helper networks and may also include helper networks configured to determine if the user is wearing a mask or not, if the user is wearing glasses or not, if the user's eyes are closed or not, if an image of the user was taken too far from or too close to the camera or image source (e.g., see 1861-1868), among other options.

Other helper networks may be used in conjunction with different embodiments to determine a state of an authentication input which may involve more than binary state conditions. In further embodiments, other authentication modalities can be processed by different helper networks. According to one embodiment, a fingerprint helper network can be configured to accept an image input of a user's fingerprint and process that image to determine if a valid authentication instance has been presented (e.g., 1870). For example, the fingerprint validation network can be configured to accept an image input and determine a state output specifying if not enough fingerprint landmarks (e.g., ridges) are present for authentication, or alternatively that enough fingerprint ridges are present (e.g., 1871). In another example, a fingerprint validation network can be configured to determine if a fingerprint image is too blurry to use (e.g., 1872). In further example, the fingerprint validation network can also be configured to determine if a fingerprint image is too close to the image source that captured it or too far from the image source that captured it (e.g., 1873). Similar to face validation, a fingerprint validation network can also be configured to identify submissions that are spoofed video (e.g., 1874), or spoofed images (e.g., 1875).

According to some embodiments, validation models can be configured to score an authentication input and based on evaluation of the score a respective state can be determined. For example, a validation helper network can produce a probability score as an output. Scores above the threshold can be classified as being one state with scores below the threshold being another. In some examples, intermediate values or probability scores can be excluded or assigned an inconclusive state.

Further embodiments are configured to execute helper networks to process additional authentication modalities. According to one embodiment, an authentication system can include voice validation helper networks (e.g., 1880) configured to accept an audio input and output of probability of validity. In one example, a voice helper network is configured to determine if too many voices are present in a sample (e.g., 1881). In another example, a voice validation network can be configured to determine if no sound is present in an audio sample (e.g., 1882). Further examples include voice validation networks configured to determine if too much external noise is present in an audio sample for proper validation (e.g., 1883).

According to some embodiments, audio spoof detection can use an induced audio signal. Such an induced audio signal can be an audible tone or frequency and may also include a signal outside human hearing. Various patterns and/or randomized sounds can be triggered to aid in presentation attack detection. Various validation networks can be configured to identify the induced audio signal as part of authentication input collection to confirm live authentication input.

Shown at 1808 are examples of multiclass models that can be based on combinations and/or collections of various binary or other state models. For example, a face validation model can incorporate a variety of operations to output a collective determination on validity based on the underlying state determinations. In one example, the face validation network (e.g., 1820) can analyze an image of a user face to determine if any of the following characteristics make the image a bad authentication input: image is too far or too close, image is too blurry, image is spoofed, video spoof produced the input, the user is wearing a mask, the user's eyes are open or closed, the user is or is not wearing eyeglasses, etc. (e.g., 1821). In other embodiments, any combination of the foregoing conditions can be tested and as few as two of the foregoing options can be tested to determine the validity. In still other embodiments, different numbers of conditions can be used to determine if an authentication input is valid.

According to other embodiments, different multiclass models can be applied to different authentication inputs. For example, at 1830 shown is a fingerprint validation model that can test a number of conditions to determine validity. In one example, a fingerprint validation network (e.g., 1831) is configured to test if enough ridges are present, if the input is a video spoof, if the input is an image spoof, if the image is too blurry, and if the image was captured too far or too close to an image source, among other options.

According to one embodiment, a voice validation network (e.g., 1840) is configured to validate an audio input as a good authentication instance. In another example, the voice validation network can be configured to determine if there are too many voices present, no sound present, if too much external noise is present in an audio input, among other options (e.g., 1841). In addition, the voice validation network can also include operations to determine liveness. In one example, an authentication system can induce an audio tone, sound, or frequency that should be detected by a validation network in order to determine that an authentication input is live and not spoofed. Certain time sequences or patterns may be induced, as well as random audio sequences and/or patterns.

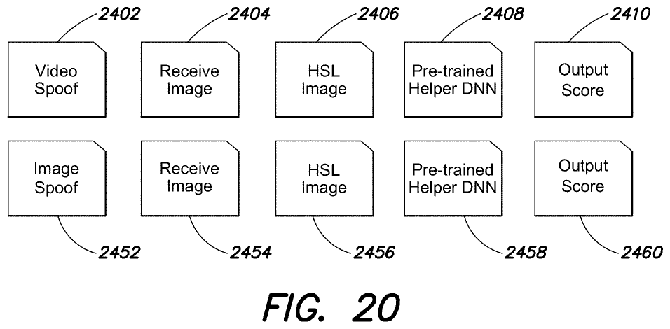

FIG. 20 is a block diagram illustrating operations performed by validation helper networks configured to determine liveness. FIG. 20 illustrates various considerations for implementing validation networks to detect input spoofing according to some embodiments. The illustrated examples of helper networks (e.g., 2408, 2458) are trained by creating a multitude of input spoofed images that are created in a variety of lighting conditions and backgrounds. The spoofed images are received at 2454, and the spoofed images are transformed into augmented image format that limits lighting effects, and limits the effects of subject skin color, and facial contour. The augmented image format can include for example an HSL image format. Various considerations for color harmonization are discussed in, “Color Harmonization,” by D. Cohen-Or et al., published 2006 by Association for Computing Machinery, Inc. Other augmentation/homogenization formats could be used including, for example, LAB color space or contrast limited adaptive histogram equalization “CLAHE” method for light normalization.

Once a variety of spoofed images are produced and the lighting conditions normalized, various additional spoofed instances can be created with multiple alignments, cropping's, zooms (e.g., in and out) to have a body of approximately two million approved images. The validation network is trained on the images and its determinations tested. After each training, false positives and false negatives remain in the training set. In some example executions, the initial two million images are reduced to about 100,000. The validation network is retrained on the remaining samples. In further embodiments, retraining can be executed repeatedly until no false positives or false negatives remain. A similar training process can be used in the context of video spoofed video inputs. A video liveness validation network can be trained similarly on false positives and false negatives until the network identifies all valid inputs without false positives or false negatives.

Once trained, processing follows a similar approach with any authentication input. Shown are two pathways one for video spoof inputs and one for image spoof inputs (e.g., 2402 and 2452 respectively). The spoofed data is received as 2404/2454 and the data is transformed into the HSL format at 2406/2456, which is processed by respective validation networks (e.g., 2408/2458—which can be, for example, pre-trained helper validation deep neural networks). In response to the input of potentially spoofed authentication data, the validation networks 2408/2458 output respective scores 2410/2460, and based on the respective scores an authentication system can determine if an authentication input is valid or simply a replay or spoof of a valid authentication input.

Unlikely some conventional systems that can use machine learning approaches to cluster images before processing, the validation networks are trained on universal characteristics that apply to all authentication inputs, and each determination of validity establishes that a singular authentication instance is valid or not. With the training as described above, various embodiments provide helper networks that are capable of presentation attack detection (e.g., spoofed submission of a valid image). Clustering of similar images alone, as done in some conventional approaches, is not expected to solve this issue, and the likely result of such an approach would include introduction of spoofed images into such clusters, which ultimately will result in incorporation into and successful attacks on resulting authentication models.

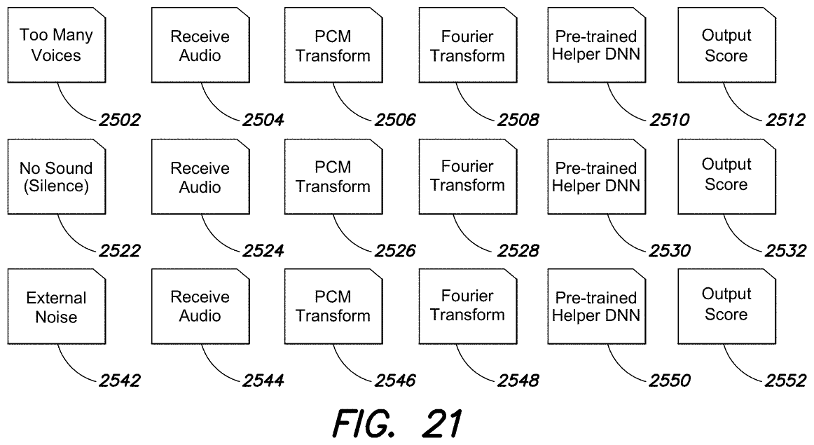

Shown in FIG. 21 are various embodiments of helper networks configured to analyze voice input and determine if a valid authentication input has been submitted. According to some embodiments, voice helper networks can be configured to determine if too many voices are present in an authentication instance, if no sound is present, and/or if external noise is too loud, among other options to validate that a good authentication instance has been provided.

According to one embodiment, voice validation helper networks are trained to identify various states to determine if an authentication instance is valid for use in authentication. The helper networks can be trained on various audio inputs. In one example, a body of audio inputs are captured that are clean and valid (e.g., capture of known valid users' voices). The initial audio data is mixed and/or modified with external noises that impact how good they are in terms of authentication sources. For example, to determine impact of the noise, an output of a voice embedding network can be used to evaluate a cosine distance between various audio inputs. Where the introduction of external noise impacts the cosine distance evaluation, those instances are useful in establishing a training data set for identifying valid/invalid audio instances.

According to one embodiment, a set of 2500 clean samples are captured and used to mix with external noises (e.g., 2500 external noises evaluated for impact on cosine distance). The 2500 initial samples are expanded and mixed with external voices until a large number of audio samples are available for training. In one example, helper networks can be trained on over eight million audio samples. Once trained, the results produced by the helper networks are tested to determine how well the helper networks identified valid data. False-positive results and false negative results are then used for subsequent training operations. According to one embodiment, millions of samples can be reduced to hundreds of thousands of false positives and false negatives. In various example executions, human perception is incapable of determining a difference between the spoofed audio and a valid instance once the training data has been reduced to the level of ˜100K instances, however, the trained model is able to distinguish between such audio samples.

In some implementations, false positives and false negatives are used repeatedly to train the model until the model is able to execute with no false positives or false negatives. Once that result is achieved or substantially close to that result (e.g., less than 1-25% false-positive/false-negative exists) the voice validation model is trained and ready for use. According to one example, an authentication system can use any number of voice validation helper networks that are pre-trained to detect spoofed audio instances.

Returning to FIG. 21, three example pre-trained voice helper networks (e.g., DNNs) are illustrated. In the first block illustrated each helper network is configured to detect a state—at 2502 too many voices, at 2522 no sound is present, and/or at 2542 too much external noise. The respective helper networks receive audio for processing (e.g., 2504, 2524, 2544). According to various embodiments, PCM is executed on received audio (e.g., 2506, 2526, 2546). The result is transformed into the frequency domain (e.g., 2508, 2528, 2548—fourier transform). The respective outputs are evaluated by pre-trained helper DNNs at 2510, 2530, and 2550. The respective helper networks are configured to output scores associated with their state evaluation. For example, the respective networks output scores at 2512, 2532, and 2552. The scores can be used to determine if the audio input is valid for use in authentication. For example, the output value can reflect a probability an instance is valid or invalid. In one implementation, values above a threshold are deemed invalid and vice versa. In further example, some ranges for probable matching can be determined to be inconclusive.

According to some embodiments, the various states described above (e.g., too many voices, no sound, external noise issues, among other options) can be tested via a merged network that incorporates the illustrated pre-trained helper networks into a single neural network, and the output represents a collective evaluation of validity of an audio input.

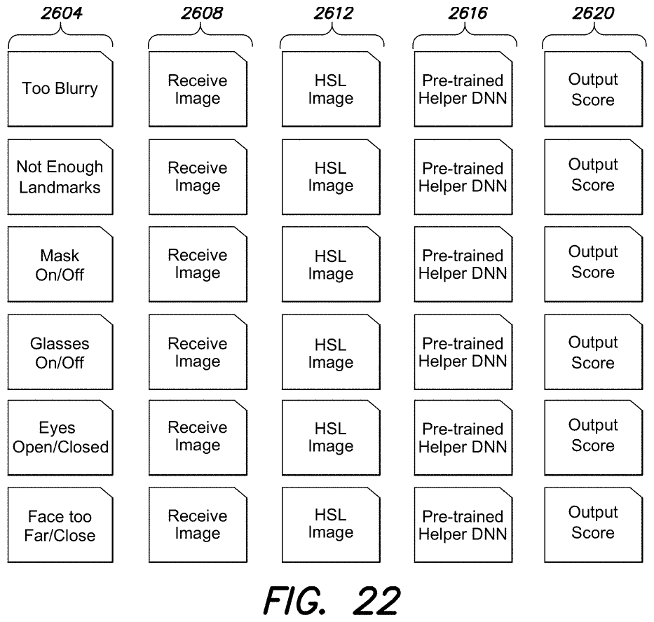

FIG. 22 illustrates a variety of helper networks configured to evaluate facial images and output a scoring for determining validity. In the first column shown in FIG. 22, the state being tested is specified. For example, at 2604 some of the states that respective helper networks can test are illustrated. Various embodiments include tests for whether an image is too blurry, does not contain enough landmarks, images a user with a mask on or off, images a user with glasses on or off, images the user with eyes closed or open, an imaged face is too far or too close to an image source or camera, etc. According to some embodiments, processing by the helper networks proceeds at column 2608 where the respective helper networks receive image data that is processed into normalized image data at 2612 (e.g., processed into an HSL image). At column 2616, the respective helper networks evaluate respective HSL images and at column 2620 output a score used to determine validity based on the evaluated state specified in column 2604.

According to various embodiments face validation helper networks are trained based on an initial set of valid input images which are taken in a variety of lighting conditions and background so that each lighting condition has multiple backgrounds and each background has multiple lighting conditions. A large training set is beneficial according to some embodiments. In some examples 500,000 images can be used to establish the variety of lighting conditions and backgrounds. The initial set of images can then be normalized to produce HSL images. Other processes can be used to normalize the training set of images. The resulting images are manipulated to generate an expanded set of training images. For example, a variety of alignments and/or cropping of the images can be executed. In other examples, and in addition or in the alternative, a variety of zoom operations (e.g., in and out) can be applied to the images. As part of expanding the training set, the images can be integrated with defects, including, adding bad lighting, occlusions, simulating light beams over a facial image, eliminating landmarks on faces present, having images that are too far and too close to an image source and or introducing blurring into the training images, among other options. The initial body of training images can be expanded significantly and for example, a set of 500,000 images can be expanded into 2 million images for a training set.

Once the training set is prepared, the helper network is trained against the data to recognized valid authentication inputs. The results produced by the helper network are evaluated. Based on the results evaluation, any false positives and any false negatives are used for further training of the model. According to one example execution, about one hundred thousand images remain that are false-positives or false-negatives after the first attempt. Training can be repeated until no new false-positive or false-negative remain, using the remaining false results to retrain. In other examples once a sufficient level of accuracy is achieved greater than 95% training can be considered complete. According to some embodiments, facial validation helper networks are architected on a deep neural network model that can identify any of a number of states associated with a facial image, and further can be used to determine if the image is valid for use in authentication.

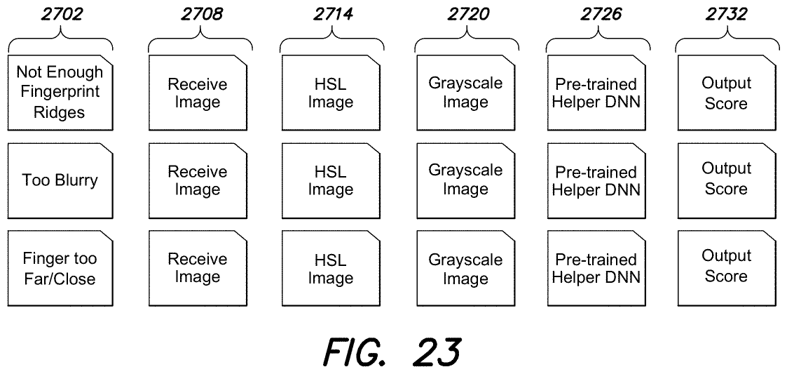

Shown in FIG. 23 is a similar approach for executing helper networks on fingerprint images, according to some embodiments. In the first column at 2702, specified is a state being tested by a respective helper network. For example, a validation helper network can determine if not enough fingerprint ridges are available, if an image is too blurry, is a fingerprint image is too far or too close to an image source, among other options. At column 2708, image data is received, and at column 2714, the received image data is transformed into HSL image format. The HSL image is reduced to a grayscale image at column 2720. The result is analyzed by respective helper networks (e.g., input to pre-trained helper DNNs) at 2726. Once analyzed, the respective networks output a score used to determine validity of the authentication instance (e.g., at column 2732).

Similar to the approach discussed with respect to FIG. 22, fingerprint image data can be captured in multiple lighting conditions and with multiple backgrounds to produce training data sets used to define the helper network models. Once a body of images is produced, the images are transformed into HSL images and then into grayscale. A variety of alignments, crops, zooms (e.g., in and out), are applied to the body of images. In addition, operations are executed to various ones of the body of training images to introduce defects. For example, bad lighting conditions can be added, as well as occlusions, introduction of light beams into images, removal of landmarks from the image, as well as using images where the fingerprint image is too far and/or too close to an image source. Other example images can include blurry fingerprint captures or introduction of blur into training data images. According to some embodiments, an initial body of 500,000 images can be expanded into a body of 2 million images to train the model.

According to one embodiment, once the expanded set of images is created a helper network model can be trained on the body of images to identify valid authentication inputs. Initially the output determination of the helper network yields false positives and false negatives. Any resulting false-positives and false negatives are used to continue training of the helper network. In one example execution, an initial set of two million images yields approximately 100,000 false-positives and/or false negatives when the helper networks results are evaluated. The helper network model is retrained based on the remaining images and tested to identify any further false-positives and/or false negatives. The approach can be repeated to refine the model until no false positives or false negatives are identified. In other embodiments, an authentication system can use a threshold level of accuracy to determine a model is fully trained for use (e.g., greater than 90% accuracy, greater than 95% accuracy, among other options).

Once respective helper networks are trained on their expanded data sets and iterated until no false positives or false negatives are output, an authentication system can execute the pre-trained helper network to determine the validity of any authentication input and filter bad inputs from use in training authentication models (e.g., embedding generation networks).

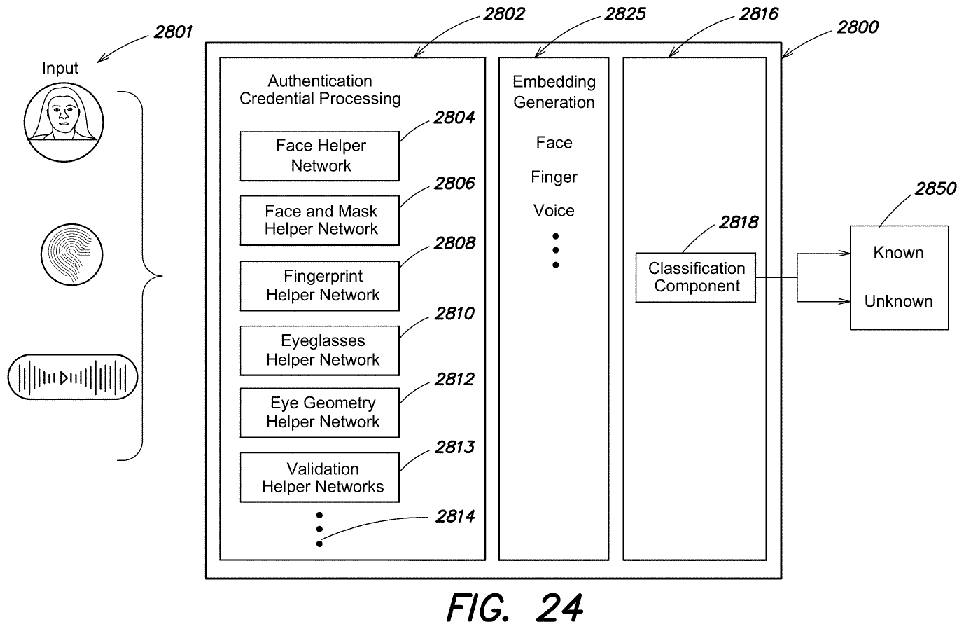

FIG. 24 is a block diagram of an example embodiment of an authentication system 2800 employing private biometrics with supporting helper networks. As shown in FIG. 24 the system can be configured to accept various authentication credentials in plain text or unencrypted form (e.g., 2801) processes the unencrypted authentication credentials (e.g., via an authentication credential processing component 2802), to ensure the input is valid and good for authentication. For example, a plurality of helper networks can process authentication input to determine validity before they a processed by embedding neural networks (e.g., 2825) into one-way homomorphic representations of the same, that can be analyzed by a classification component (e.g., 2818) to determine if submitted credentials matched enrolled credentials (e.g., return known for match or unknown at 2850), for example, with a neural network trained on encrypted feature vectors produced by the embedding networks. Evaluations of matches can be validated for example, with a validation component 2820 that is configured to provide validation function once matches or unknown results are determined. In further embodiments, the classification component can operate by itself and in others as a part of a classification subsystem 2816 that can also include various validation functions to confirm matches or unknown results.

Various embodiments include architectures that separate authentication credential processing (e.g., 2802) from operations of the classification subsystem (e.g., 2816), and other embodiments can provide either or both operations as a service-based architecture for authentication on private encryptions of authentication credentials.

The various functions, processes, and/or algorithms that can be executed by the authentication credential processing component 2802 are discussed throughout, and the various functions, processes, and/or algorithms that can be executed by the classification subsystem 2816 are also described with respect to the co-pending U.S. patent application Ser. No. 16/832,014, incorporated by reference in its entirety. FIG. 24 is included to provide some examples of helper networks and support functionality and/or algorithms that can be incorporated in the various examples, embodiments, and aspects disclosed herein. The following descriptions focus on the helper network functions to provide illustration, but are not limited to the examples discussed with FIG. 24.

For example, credential processing can include various helper networks (e.g., face 2804, face and mask 2806, fingerprint 2808, eyeglasses 2810, eye geometry 2812, and the “ . . . ” at 2814, and the preceding networks can each be associated with a validation network configured to determine the validity of the submitted/processed authentication instance. In some examples, geometry or processing networks (e.g., 2804 & 2808) are configured to identify relevant characteristics in respective authentication input (e.g., position of eyes in a face image, position of ridges in a fingerprint image respectively, etc.). The output of such networks is then validated by a validation network trained on that type of authentication input. The “ . . . ” at 2814 illustrates the option of including additional helper networks, and/or processing functions, where any number or combination of helper network can be used in any combination with various embodiments disclosed herein.

According to some embodiments, the helper networks can be based on similar neural network architectures, including, for example, Tensorflow models that are lightweight in size and processing requirements. In further examples, the helper networks can be configured to execute as part of a web-based client that incorporates pre-trained neural networks to acquire, validate, align, reduce noise, transform, test, and once validated to communicate validated data to embedding networks to produce, for example, one-way encrypt input authentication credentials. Unlike many conventional approaches, the lightweight helper networks can be universally employed by conventional browsers without expensive hardware or on-device training. In further example, the helper networks are configured to operate with millisecond response time on commercially available processing power. This is in contrast to many conventional approaches that require specialized hardware and/or on-device training, and still that fail to provide millisecond response time.

According to some embodiments, various helper networks can be based on deep neural network architectures, and in further examples, can employ you only look once (“YOLO”) architectures. In further embodiments, the helper networks are configured to be sized in the range of 10 kB to 100 kB, and are configured to process authentication credentials in <10 ms with accuracies >99%. The data footprint of these helper network demonstrates improved capability over a variety of systems that provide authentication based on complex, bulky, and size intensive neural network architectures.

According to one aspect, each authentication credential modality requires an associated helper DNN—for example, for each biometric type one or more tailored helper networks can be instantiated to handle that biometric type. In one example, a face helper network and a fingerprint helper network (e.g., 2804 and 2808) can be configured to identify specific landmarks, boundaries, and/or other features appearing in input authentication credentials (e.g., face and fingerprint images respectively). Additional helper networks can include face and fingerprint validation models configured to determine that the submitted authentication credential is valid. Testing for validity can include determining that a submitted authentication credential is a good training data instance. In various embodiments, trained validation models are tailored during training so that validated outputs improve the entropy of the training data set, either expanding the circumstances in which trained models will authenticate correctly or refining the trained model to better distinguish between authentication classes and/or unknown results. In one example, distances metrics can be used to evaluate outputs of an embedding model. For example, valid instances improve the distance measure between dissimilar instances as well as to identify similar instances, and the validity networks can be trained to achieve this property.

In the context of image data, a validation helper network can identify if appropriate lighting and clarity is present. Other helper networks can provide processing of image data prior to validation, for example, to support crop and align functions performed on the authentication credentials prior to communication to embedding network for transforming them into one-way encryptions.

Other options include: helper networks configured to determine if an input credential includes an eyes open/eyes closed state—which can be used for passive liveness in face recognition settings, among other options; helper networks configured to determine an eyeglasses on or eyeglasses off state within an input credential. The difference in eyeglass state can be used by the system to improve enrollment data quality in face recognition. Further options include data augmentation helper networks for various authentication credential modalities that are configured to increase the entropy of the enrollment set, for example, based on increasing the volume and robustness of the training data set.

In the voice biometric acquisition space, helper networks (e.g., helper DNNs) can be configured to isolate singular voices, and voice geometry voice helper networks can be trained to isolate single voices in audio data. In another example, helper network processing can include voice input segmentation to acquire voice samples using a sliding time (e.g., 10 ms) window across, for example, one second of input. In some embodiments, processing of voice data includes pulse code modulation transformation that down samples each time segment to 2× the frequency range, which may be coupled with voice fast fourier transforms to convert the signal from the time domain to the frequency domain.

Various embodiments can use any one or more and/or any combination of the following helper networks and/or associated functions. In one embodiment, the system can include a helper network that includes a face geometry detection DNN. The face geometry DNN can be configured to support locating face(s) and associated characteristics in an image by transforming each image into geometric primitives and measuring the relative position, width, and other parameters of eyes, mouth(s), nose(s), and chin(s).

Facial recognition functions can be similar to fingerprint recognition functions executed by fingerprint helper networks as both networks process similar modalities (e.g., image data and identification of structures within the images data to build an authentication representation). According to one embodiment, a helper network can include a fingerprint geometry detection DNN configured to accurately locate finger(s) in an image, and analysis can include transforming each image into geometric primitives to measure each finger's relative position, width, and other parameters. In one example, helper networks that process image data can be configured to identify relevant structures in the image and return positional information in the image (e.g., X and Y coordinates), video frame, and/or video stream submitted for processing of the relevant structures. In one example, geometry networks process image credentials and their output can be used in validating the authentication instance or rejecting the instance as invalid.

In another embodiment, a helper network can include a face validation DNN configured validate face input images (e.g., front looking face images). In various embodiments, the validation DNN is configured to validate any one or more or any combination of the following: a valid image input image was received, the submitted image data has forward facing face images, the image includes features consistent with a facial image (e.g., facial characteristics are present, and/or present in sufficient volume, etc.); lighting is sufficient; boundaries within image are consistent with facial images, etc.

Similarly, a helper network can include a fingerprint validation DNN configured to validate fingerprint input images. Such validation networks can be configured to return a validation score used to determine if an image is valid for further processing. In one example, the validation networks can return a score in the range between 0 to 100, where 100 is a perfect image, although other scoring systems and/or ranges can be used.

In further embodiments, a helper network can include one or more image state detection neural networks. The image state neural networks can be configured to detect various states (e.g., binary image conditions (e.g., face mask on/face mask off, eye open yes/eye open no, etc.)) or other more complex state values. The state values can be used in authentication credential processing. In one example, the system can employ an image state value to select an embedding generation neural network or to select a neural network to process an input authentication credential, among other options. In one example, a detection helper network can include a face mask detection DNN configured to determine if image data includes an entity wearing a face mask.

In further example, the system can also execute face mask detection algorithms to determine if a subject is wearing a mask. Stated broadly, masks used during enrollment lower subsequent prediction performance. In some embodiments, the face+mask on/off detection DNN accepts a face input image (e.g., a forward-looking facial image) and returns a value 0 to 100, where 0 is mask off and 100 is mask on. Various thresholds can be applied to a range of values to establish an on/off state.

In one example, a web client can include a URL parameter for enrollment and prediction (e.g., “maskCheck=true”), and based on the output (e.g., state=Mask On) can communicate real-time instructions to the user to remove the mask. In other examples, the system can be set to automatically select a face+mask embedding DNN tailored to process images with face and masks. In various embodiments, the face+mask embedding DNN is a specialized pre-trained neural network configured to process user image data where the user to be authenticated is wearing a mask. A corresponding classification network can be trained on such data (e.g., one-way encryptions of image data where users are in masks), and once trained to predict matches on user's wearing masks.

In another embodiment, a helper network can be configured to determine a state of image data where a user is or is not wearing glasses. In one example, a detection helper network can include an eyeglasses detection DNN configured to determine if image data includes an entity wearing eyeglasses. In further example, the system can also execute eyeglass helper network to determine if a subject is wearing eyeglasses. In one example, the system can also execute an eyeglass detection algorithm to determine if a subject is wearing eyeglasses before allowing enrollment. Stated broadly, eyeglasses used during enrollment can lower subsequent prediction performance. In some embodiments, the eyeglasses on/off detection DNN accepts a front view of face input image, returns a value 0 to 100, where 0 is eyeglasses off and 100 is eyeglasses on. In some embodiments, various thresholds can be applied to a range of values to establish an on/off state. For example, Values above 50 can be assign an on state with values below 50 an off state (or, for example, above 50/below 50). Intermediate values can be deemed inconclusive or in other embodiments the complete range between 0 to 100 can be assigned to either state.

Various authentication system can test if a user is wearing glasses. For example, a web client can include a URL parameter for enrollment and prediction (e.g., “eyeGlassCheck=true”), and based on the output (e.g., state=Glasses On) can communicate real-time instructions to the user to remove the glasses. In other embodiments, generation/classification networks can be trained on image data of a user with glasses and the associated networks can be selected based on processing images of users with glasses and predicting on encrypted representations of the same.

In another embodiment, a helper network can include an eye geometry detection DNN. The detection DNN is configured to locate eye(s) in an image by transforming a front facing facial image into geometric primitives and measuring relative position of the geometric primitives. In one example, the DNN is configured to return positional information (e.g., x, y coordinates) of eyes in an image, video frame or video stream.

In one embodiment, a helper network can include an eyes open/closed detection DNN. For example, a real-time determination that an entity seeking authentication is blinking provides real-time passive facial liveness confirmation. Determining that a user is actually submitting their authentication information at the time of the authentication request prevents spoofing attacks (e.g., holding up an image of an authentic user). In various examples, the system can include algorithms to test liveness and mitigate the risk of a photo or video spoofing attack during unattended operation. In one example, the eye open detection DNN receives an input image of an eye and outputs a validation score between 0 and 100, where 0 is eyes closed and 100 is eyes open. Various thresholds can be applied to a range of values to establish an eye open/closed state as discussed herein.

According to one embodiment, the authentication system prevents a user/entity from proceeding until the detection of a pair of eye-open/eye-closed events. In one example, the web client can be configured with a URL parameter “faceLiveness=true” that allows the system to require an eye-blink check. The parameter can be used to change operation of blinking testing and/or default settings. In further examples, rates of blinking can be established and linked to users as behavioral characteristics to validate.

In some embodiments, helper networks can be configured to augment authentication credential data. For example, a helper network can include facial and fingerprint augmentation DNNs that are used as part of training validation networks. In various embodiments, data augmentation via helper networks is configured to generalize the enrollment of authentication information, improve accuracy and performance during subsequent prediction, and allow the classification component and/or subsystem to handle real-world conditions. Stated generally, enrollment can be defined on the system to require a certain number of instances to achieve a level of accuracy while balancing performance. For example, the system can require >50 instances of an authentication credential (e.g., >50 biometric input images) to maintain accuracy and performance. The system can be configured to execute algorithms to augment valid credential inputs to reach or exceed 250 instances. For example, a set of images can be expanded to 250 or more instances that can also be broadened to add boundary conditions to generalize the enrollment. The broadening can include any one or more and/or any combination of: enhanced image rotations flips, color and lighting homogenizations, among other options. Each instance of an augmentation can be tested to require improvement in evaluation of the distance metric (Euclidean distances or cosine similarity) comparison, and also be required not to surpass class boundaries. For example, the system can be configured to execute algorithms to remove any authentication credentials (e.g., images) that exceed class boundaries. Once filtered, the remaining images challenge the distance metric boundaries without surpassing them.

In the example of image data used to authenticate, if only one image is available for enrollment, the system is configured to augment the facial input image >50 (e.g., 260, 270, 80, etc.) times, remove any outliers, and then enroll the user. According to one embodiment, the web client is configured to capture 8 images, morphs each image, for example, 9 times, remove any outliers and then enroll the user. As discussed, the system can be configured to require a baseline number of instances for enrollment. For example, enrollment can require >50 augmented biometric input images to maintain the health, accuracy and performance of the recognition operations. In various embodiments, the system accepts biometric input image(s), morphs and homogenizes the lighting and contrast once, and discards the original images once encrypted representations are produced.

It is realized that that there is no intrinsic requirement to morph images for prediction. Thus, some embodiments are configured to morph/augment images only during enrollment. In other embodiments, the system can also be configured to homogenize images submitted for prediction (e.g., via HSL transforms, etc.). In some examples, homogenized images used during prediction can increase system performance when compared to non-homogenized images. According to some examples, image homogenization can be executed based on convenience libraries (e.g., in Python and JavaScript). According to some embodiments, during prediction the web client is configured to capture three images, morph and homogenize the lighting and contrast once, and then discards the original images once encrypted representations are generated.

In various embodiments, helper networks can be configured to support transformation of authentication credentials into encrypted representations by pre-trained neural networks (e.g., referred to as embedding networks or generation networks). The embedding networks can be tailored to specific authentication credential input. According to one embodiment, the system includes face, face+mask, and fingerprint embedding neural networks, among others. Where respective embedding networks are configured to transform the input image to a distance measurable one-way homomorphic encryption (e.g., embedding, or vector encryption) which can be a two-dimensional positional array of 128 floating-point numbers.

In various implementations, face, face+mask, and fingerprint embedding neural networks maintain full accuracy through real-world boundary conditions. Real world conditions have been tested to include poor lighting; inconsistent camera positioning; expression; image rotation of up to 22.5°; variable distance; focus impacted by blur and movement; occlusions of 20-30% including facial hair, glasses, scars, makeup, colored lenses and filters, and abrasions; and B/W and grayscale images. In various embodiments, the embedding neural networks are architected on the MobileNetV2 architecture and are configured to output a one-way encrypted payload in <100 ms.

In various embodiments, voice input can include additional processing. For example, the system can be configured to execute voice input segmentation that generalizes the enrollment data, improves accuracy and performance during prediction, and allows the system to handle real-world conditions. In various embodiments, the system is configured to require >50 10 ms voice samples, to establish a desired level of accuracy and performance. In one example, the system is configured to capture voice instances based on a sliding 10 ms window that can be captured across one second of voice input, which enables the system to reach or exceed 250 samples.

In some embodiments, the system is configured to execute pulse code modulation to reduce the input to two times the frequency range, and PCM enables the system to use the smallest possible Fourier transform without computational loss. In other embodiments, the system is configured to execute voice fast fourier transform (FFT) which transforms the pulse code modulated audio signal from the time domain to a representation in the frequency domain. According to some examples, the transform output is a 2-dimensional array of frequencies that can be input to a voice embedding DNN. For example, the system can include a voice embedding network that is configured to accept input of one 2-dimensional array of frequencies and transform the input to a 4 kB, 2-dimensional positional array of 128 floating-point numbers (e.g., cosine-measurable embedding and/or 1-way vector encryption), and then deletes the original biometric.

According to various embodiments, the web client can be configured to acquire authentication credentials (e.g., biometrics) at the edge with or without a network. For example, the web client can be configured to automatically switch to a local mode after detection of loss of network. According to some embodiments, the web client can support offline operation (“local mode”) using Edge computing. In one example, the device in local mode authenticates a user using face and fingerprint recognition, and can do so in 10 ms with intermittent or no Internet connection. In some embodiments, the device is configured to store the user's embeddings and/or encrypted feature vectors locally using a web storage API during the prediction.

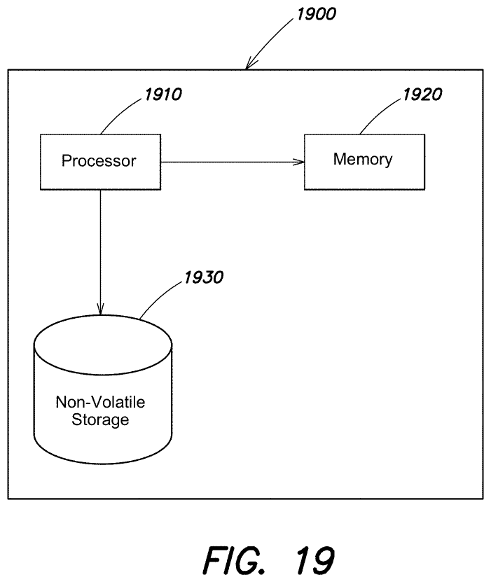

Modifications and variations of the discussed embodiments will be apparent to those of ordinary skill in the art and all such modifications and variations are included within the scope of the appended claims. An illustrative implementation of a computer system 1900 that may be used in connection with any of the embodiments of the disclosure provided herein is shown in FIG. 19. The computer system 1900 may include one or more processors 1910 and one or more articles of manufacture that comprise non-transitory computer-readable storage media (e.g., memory 1920 and one or more non-volatile storage media 1930). The processor 1910 may control writing data to and reading data from the memory 1920 and the non-volatile storage device 1930 in any suitable manner. To perform any of the functionality described herein, the processor 1910 may execute one or more processor-executable instructions stored in one or more non-transitory computer-readable storage media (e.g., the memory 1920), which may serve as non-transitory computer-readable storage media storing processor-executable instructions for execution by the processor 1910. The terms “program” or “software” are used herein in a generic sense to refer to any type of computer code or set of processor-executable instructions that can be employed to program a computer or other processor to implement various aspects of embodiments as discussed above. Additionally, it should be appreciated that according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in one or more non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

Also, various inventive concepts may be embodied as one or more processes, of which examples (e.g., the processes described above, etc.) have been provided. The acts performed as part of each process may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, and/or ordinary meanings of the defined terms. As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

What is claimed is:

1. A private identity system, the system comprising:
at least one processor operatively connected to a memory, the at least one processor configured to:
instantiate at least one pre-trained embedding network configured to generate encrypted feature vectors from an input of plaintext identifying information;
instantiate at least one classification network configured to:
accept the encrypted feature vectors and label inputs to train the at least one classification network to recognize the encrypted features, and
accept the encrypted feature vectors and return a matching label to an identity or an unknown result during prediction;
assign a unique identifier to respective encrypted feature vectors to return in response to geometric evaluation and for training the at least one classification network using the unique identifier as a respective label; and
trigger a plurality of identifications of a device user during a use session, based, at least in part, on a plurality of triggering events.

2. The system of claim 1, wherein the plaintext identifying information includes at least one of: biometric identifying information, behavioral identifying information, or physiologic identifying information.

3. The system of claim 1, wherein the plurality of triggering events include, at least, a time based trigger, periodic triggers, asynchronous triggers, or event detection.

4. The system of claim 3, wherein the at least one processor is configured to monitor sensors inputs from a user device to capture identifying information on the user based on proximity sensing, sensor feeds, monitoring camera input, monitoring device usage, or monitoring audio input.

5. The system of claim 1, wherein the at least one processor is configured to terminate a use session responsive to an unknown result or responsive to matching another user.

6. The system of claim 1, wherein the at least one processor is configured to identify multiple users from sensor input, and manage device access according to permissions associated with the user and any other user.

7. The system of claim 6, wherein the at least one processor is configured to obscure content displayed on the user device based on permissions associated with the any other user while identifying the user is present.

8. The system of claim 1, wherein the at least one processor is configured to maintain the current use session based on identifying the user and alter a display of content based on identifying another user from the plurality of identifications.

9. The system of claim 1, wherein the at least one processor is configured to control access to services or content on the user device based on repeated identification of the user from sensor information.

10. The system of claim 1, wherein the at least one processor is configured to identify the user based on geometric evaluation of encrypted feature vectors and prediction by at least one classification network.

11. The system of claim 10, wherein the at least one processor is configured to return the unique identifier associated with the user responsive to a valid geometric evaluation or prediction by the at least one classification network.

12. The system of claim 11, wherein the at least one processor is configured to retrieve a user profile associated with the unique identifier and tailor operation of the user device according to definition in the user profile.

13. The system of claim 12, wherein the at least one processor is configured to terminate a first user session in response to a failed identification of the user, an unknown result, or an identification of a second user.

14. The system of claim 13, wherein the at least one processor is configured to retrieve a second user profile associated the second user and tailor operation of the user device according to definitions in the second user profile.

15. The system of claim 1, wherein the at least one processor is further configured to return an identity responsive to geometric matching executed on encrypted feature vectors generated from an input of plaintext identifying information for the entity against stored encrypted feature vectors.

16. The system of claim 15, wherein the at least one processor is further configured to communicate at least one encrypted feature for prediction by the at least one classification network responsive to generating an unknown result from the geometric match.

17. A computer implemented method for private identity system, the method comprising:
instantiating, by at least one processor, at least one pre-trained embedding network configured to generate encrypted feature vectors from an input of plaintext identifying information;
instantiating, by the at least one processor, at least one classification network;
accepting, by the at least one classification network, the encrypted feature vectors and label inputs and training the at least one classification network to recognize the encrypted features;
accepting, by the at least one classification network, the encrypted feature vectors and return a matching label to an identity or an unknown result during prediction;
assigning, by the at least one processor, a unique identifier to respective encrypted feature vectors to return in response to geometric evaluation of the encrypted feature vectors and for training the at least one classification network using the unique identifier as a respective label; and
triggering, by the at least one processor, a plurality of identifications of a device user during a use session, based, at least in part, on a plurality of triggering events.

18. The method of claim 17, wherein the plaintext identifying information includes at least one of: biometric identifying information, behavioral identifying information, or physiologic identifying information.

19. The method of claim 17, wherein the method further comprises triggering the plurality of identifications based on, at least one of: a time based trigger, periodic triggers, asynchronous triggers, or event detection.

20. The method of claim 19, wherein the method further comprises monitoring sensors inputs from a user device to capture identifying information on the user based on proximity sensing, sensor feeds, monitoring camera input, monitoring device usage, or monitoring audio input.

21. The method of claim 21, wherein the method further comprises terminating a use session responsive to an unknown result or responsive to matching another user.

22. The method of claim 17, wherein the method further comprises identifying multiple users from sensor input, and manage device access according to permissions associated with the user and any other user.

23. The method of claim 22, wherein the method further comprises obscuring content displayed on the user device based on permissions associated with the any other user while identifying the user is present.

24. The method of claim 17, wherein the method further comprises maintaining the current use session based on identifying the user and alter a display of content based on identifying another user from the plurality of identifications.

25. The method of claim 17, wherein the method further comprises controlling access to services or content on the user device based on repeated identification of the user from sensor information.

26. The method of claim 17, wherein the method further comprises identifying the user based on geometric evaluation of encrypted feature vectors and prediction by at least one classification network.

27. The method of claim 26, wherein the method further comprises returning the unique identifier associated with the user responsive to a valid geometric evaluation or prediction by the at least one classification network.

28. The method of claim 27, wherein the method further comprises retrieving a user profile associated with the unique identifier and tailor operation of the user device according to definition in the user profile.

29. The method of claim 28, wherein the method further comprises terminating a first user session in response to a failed identification of the user, an unknown result, or an identification of a second user.

30. The method of claim 29, wherein the method further comprises retrieving a second user profile associated the second user and tailor operation of the user device according to definitions in the second user profile.

31. The method of claim 17, wherein the method further comprises returning an identity responsive to geometric matching executed on encrypted feature vectors generated from an input of plaintext identifying information for the entity against stored encrypted feature vectors.

32. The method of claim 31, wherein the method further comprises communicating at least one encrypted feature for prediction by the at least one classification network responsive to generating an unknown result from the geometric match.
